(19) United States
(12) Patent Application Publication
(10) Pub. No.: US 2026/0045519 A1
(43) Pub. Date: Feb. 12, 2026

(54) NaSICON Prepared by Solution-Assisted Reaction for High-Voltage Aqueous Redox-Flow Batteries

(71) Applicant: THE REGENTS OF THE UNIVERSITY OF MICHIGAN, ANN ARBOR, MI (US)

(72) Inventors: David Kwabi, ANN ARBOR, MI (US); Jeffrey Sakamoto, ANN ARBOR, MI (US)

(21) Appl. No.: 19/291,840

(22) Filed: Aug. 6, 2025

Related U.S. Application Data
(60) Provisional application No. 63/679,821, filed on Aug. 6, 2024.

(51) Int. Cl. H01M 8/0217; H01M 8/18

(52) U.S. Cl. CPC H01M 8/0217; H01M 8/188

(57) ABSTRACT

An ion-exchange membrane comprises a ceramic material having Formula (I):

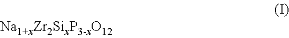

wherein x is between 0 and 3, and wherein the ceramic material has an area % of a glassy phase of less than 15% when determined using scanning electron microscopy imaging analysis. An aqueous redox flow cell comprises: a positive electrode; a negative electrode; a posolyte compartment containing a posolyte wherein at least a part of the positive electrode contacts the posolyte; a negolyte compartment containing a negolyte wherein at least a part of the negative electrode contacts the negolyte; and an ion-exchange membrane positioned to separate the positive electrode and the posolyte from the negative electrode and the negolyte, wherein the ion-exchange membrane comprises a ceramic material having Formula (I):

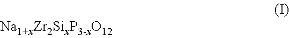

wherein x is between 0 and 3.

### CROSS-REFERENCES TO RELATED APPLICATIONS

This application is based on, claims benefit of, and claims priority to U.S. Application No. 63/679,821 filed on Aug. 6, 2024, which is hereby incorporated by reference herein in its entirety for all purposes.

### STATEMENT REGARDING FEDERALLY SPONSORED RESEARCH

This invention was made with government support under grant DE-S00023438 awarded by the Department of Energy. The government has certain rights in the invention.

### BACKGROUND OF THE INVENTION

### 1. Field of the Invention

This invention relates to ion-exchange membranes, ion-exchange membranes that can be used in redox flow cells, and methods of making ion-exchange membranes.

### 2. Description of the Related Art

Redox-flow batteries (RFBs) are a promising technology for low-cost, long-duration storage of electricity and thereby for encouraging widespread use of intermittently available renewable power (e.g., solar power and wind power). Their design differs from enclosed, conventional (e.g., Li-ion) batteries in that energy storage and power conversion are decoupled: energy is stored in a pair of separate electrolytes that contain redox-active molecular/ionic charge carriers, whereas power conversion occurs via redox reactions involving these carriers in an electrochemical cell. At high ratios of energy to power, or long discharge durations at rated power, the overall cost of the system approaches the chemical cost of the electrolytes. For the levelized cost of electricity delivered by RFBs to be competitively low, the charge carriers should be stable and should not cross over from one electrolyte to the other through the membrane in the electrochemical cell. Crossover may lead to irreversible capacity loss during cycling of an RFB.

Ceramic ion conductors (CICs) can eliminate such crossover in RFBs and still function effectively as ion-exchange membranes due to their high relative densities (>95%) and close-to-unity transference numbers for specific ions (e.g., Li⁺ or Na⁺). A well-studied CIC membrane for RFBs is NaSICON (Sodium Super Ionic Conductor), which has the chemical formula Na₁₊ₓZr₂SixP₃₋ₓO₁₂ with 0<x<3. NaSICON is promising for use in aqueous RFBs as it is macroscopically stable in water and has a bulk conductivity at room temperature of up to 15 mS/cm for Na₃Zr₂Si₂PO₁₂. NaSICON is conventionally synthesized via a high-temperature, solid-state route. This method is energy intensive and results in a complex microstructure comprising multiple phases: (1) micron-scale crystalline grains with a monoclinic or rhombohedral structure, (2) an amorphous/glassy phase between grains comprising Na, Si and Zr, and (3) ZrO₂. Past studies have demonstrated that the glassy phase is susceptible to etching in water.

Thus, while sodium superionic conductors (NaSICONs) have garnered considerable attention as ion-exchange membranes in aqueous redox-flow batteries because they can eliminate crossover-induced capacity fade, two challenges to their practical use are microstructural instability in aqueous solutions and low total conductivity which causes high cell resistance.

What is needed therefore are improved sodium superionic conductors that have greater microstructural stability in aqueous electrolytes and at higher voltages.

### SUMMARY OF THE INVENTION

The present disclosure meets the foregoing needs by providing improved ion-exchange membranes, improved ion-exchange membranes that can be used in redox flow cells, and methods of making ion-exchange membranes.

In one aspect, the present disclosure provides an ion-exchange membrane comprising:
a ceramic material having Formula (I):

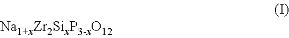

wherein x is between 0 and 3, and wherein the ceramic material has an area % of a glassy phase of less than 15% when determined using scanning electron microscopy imaging analysis.

In one embodiment of the ion-exchange membrane, the area % of the glassy phase is less than 10% when determined using scanning electron microscopy imaging analysis. In one embodiment of the ion-exchange membrane, the area % of the glassy phase is less than 5% when determined using scanning electron microscopy imaging analysis. In one embodiment of the ion-exchange membrane, the area % of the glassy phase is less than 3% when determined using scanning electron microscopy imaging analysis.

In one embodiment of the ion-exchange membrane, the ceramic material has an area % of a ZrO₂ phase of less than 5% when determined using scanning electron microscopy imaging analysis. In one embodiment of the ion-exchange membrane, the area % of the ZrO₂ phase is less than 3% when determined using scanning electron microscopy imaging analysis.

In one embodiment of the ion-exchange membrane, the ceramic material has an area % of grains of greater than 80% when determined using scanning electron microscopy imaging analysis. In one embodiment of the ion-exchange membrane, the ceramic material has an area % of grains of greater than 90% when determined using scanning electron microscopy imaging analysis. In one embodiment of the ion-exchange membrane, the ceramic material has an area % of grains of greater than 95% when determined using scanning electron microscopy imaging analysis.

In one embodiment of the ion-exchange membrane, the ceramic material exhibits no observable microstructural changes as indicated by scanning electron microscopy after immersion in 1 M KCl for 24 hours. In one embodiment of the ion-exchange membrane, the ceramic material comprises a mixture of rhombohedral and monoclinic phases.

In one embodiment of the ion-exchange membrane, x is between 2 and 3. In one embodiment of the ion-exchange membrane, the ceramic material has the formula: Na_{3.4}Zr₂Si_{2.4}P_{0.6}O₁₂.

In one embodiment of the ion-exchange membrane, the ceramic material has a relative density of greater than 95%.

In another aspect, the present disclosure provides a method for making an ion-exchange membrane. The method comprises: (a) combining a first solid comprising sodium, a second solid comprising silicon, and a third solid comprising phosphorus to form a first mixture; (b) adding a solution of a zirconium-containing compound to the first mixture to create a second mixture; (c) heating the second mixture at a temperature in a range of 30° C. to 100° C. and drying to form a powder; and (d) applying simultaneous heat and pressure to the powder to form an ion-exchange membrane comprising a ceramic material having a Formula (I):

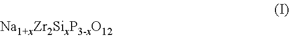

wherein x is between 0 and 3. In one embodiment of the method, x is between 2 and 3.

In one embodiment of the method, the ceramic material has an area % of a glassy phase of less than 15% when determined using scanning electron microscopy imaging analysis. In one embodiment of the method, the ceramic material has an area % of a glassy phase of less than 10% when determined using scanning electron microscopy imaging analysis. In one embodiment of the method, the ceramic material has an area % of a glassy phase of less than 5% when determined using scanning electron microscopy imaging analysis.

In one embodiment of the method, the ceramic material has an area % of a ZrO₂ phase of less than 5% when determined using scanning electron microscopy imaging analysis. In one embodiment of the method, the ceramic material has an area % of grains of greater than 80% when determined using scanning electron microscopy imaging analysis.

In one embodiment of the method, step (d) comprises using a hot-pressing technique. In one embodiment of the method, the hot-pressing technique uses at least one of induction heating, indirect resistance heating, or direct hot-pressing. In one embodiment of the method, step (d) comprises using rapid-induction hot-pressing.

In one embodiment of the method, the heat is applied at a temperature in a range of 1000° C. to 1400° C. In one embodiment of the method, the heat is applied at a temperature in a range of 1200° C. to 1300° C.

In one embodiment of the method, the pressure applied is between 5 and 80 MPa. In one embodiment of the method, the pressure applied is between 20 and 40 MPa.

In one embodiment of the method, the first solid comprises a sodium salt. In one embodiment of the method, the first solid comprises sodium metasilicate. In one embodiment of the method, the second solid comprises an alkyl silicate.

In one embodiment of the method, the second solid comprises tetraethyl orthosilicate. In one embodiment of the method, the third solid comprises a phosphate. In one embodiment of the method, the third solid comprises ammonium dihydrogen phosphate.

In one embodiment of the method, the zirconium-containing compound comprises a zirconium salt. In one embodiment of the method, the zirconium-containing compound comprises zirconium hydroxide nitrate.

In one embodiment of the method, the ceramic material has a relative density above 95%.

In one embodiment of the method, step (c) further comprises calcining the powder. In one embodiment of the method, the calcining occurs at a temperature in a range of 600° C. to 800° C.

In one embodiment of the method, step (a) comprises combining the first solid, the second solid, and the third solid in an aqueous solvent.

In yet another aspect, the present disclosure provides an aqueous redox flow cell comprising: a positive electrode; a negative electrode; a posolyte compartment containing a posolyte wherein at least a part of the positive electrode contacts the posolyte; a negolyte compartment containing a negolyte wherein at least a part of the negative electrode contacts the negolyte; and an ion-exchange membrane positioned to separate the positive electrode and the posolyte from the negative electrode and the negolyte, wherein the ion-exchange membrane comprises a ceramic material having Formula (I):

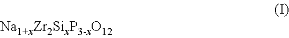

wherein x is between 0 and 3, and wherein the ceramic material has an area % of a glassy phase of less than 15% when determined using scanning electron microscopy imaging analysis. In one embodiment of the aqueous redox flow cell, x is between 2 and 3.

In one embodiment of the aqueous redox flow cell, the area % of the glassy phase is less than 10% when determined using scanning electron microscopy imaging analysis. In one embodiment of the aqueous redox flow cell, the ceramic material has an area % of a ZrO₂ phase of less than 5% when determined using scanning electron microscopy imaging analysis. In one embodiment of the aqueous redox flow cell, the ceramic material has an area % of grains of greater than 80% when determined using scanning electron microscopy imaging analysis.

In one embodiment of the aqueous redox flow cell, the flow cell further comprises: a posolyte reservoir in fluid communication with the posolyte compartment; a posolyte pump for circulating the posolyte in the posolyte compartment; a negolyte reservoir in fluid communication with the negolyte compartment; and a negolyte pump for circulating the negolyte in the negolyte compartment.

In one embodiment of the aqueous redox flow cell, the flow cell has an open-circuit voltage greater than 1.5 V. In one embodiment of the aqueous redox flow cell, the flow cell has an open-circuit voltage greater than 1.6 V. In one embodiment of the aqueous redox flow cell, the flow cell has an open-circuit voltage greater than 1.8 V.

In one embodiment of the aqueous redox flow cell, the flow cell has an area-specific conductance greater than 0.02 ohm⁻¹ cm⁻². In one embodiment of the aqueous redox flow cell, the flow cell has an area-specific conductance greater than 0.03 ohm⁻¹ cm⁻². In one embodiment of the aqueous redox flow cell, the flow cell has an area-specific conductance greater than 0.04 ohm⁻¹ cm⁻². In one embodiment of the aqueous redox flow cell, the flow cell has an area-specific conductance greater than 0.05 ohm⁻¹ cm⁻². In one embodiment of the aqueous redox flow cell, the flow cell has an area-specific conductance greater than 0.001 ohm⁻¹ cm⁻². In one embodiment of the aqueous redox flow cell, the flow cell has an area-specific conductance greater than 0.01 ohm⁻¹ cm⁻². In one embodiment of the aqueous redox flow cell, the flow cell has an area-specific conductance in a range of 0.001 ohm⁻¹ cm⁻² to 0.06 ohm⁻¹ cm⁻². In one embodiment of the aqueous redox flow cell, the flow cell has an area-specific conductance in a range of 0.02 ohm⁻¹ cm⁻² to 0.06 ohm⁻¹ cm⁻².

In one embodiment of the aqueous redox flow cell, the posolyte comprises Na₂MnO₄.

In one embodiment of the aqueous redox flow cell, the flow cell is a hybrid flow cell.

In one embodiment of the aqueous redox flow cell, the negolyte comprises sodium cations and zinc-containing anions. In one embodiment of the aqueous redox flow cell, the zinc-containing anions comprise tetrahydroxozincate anions.

In one embodiment of the aqueous redox flow cell, the flow cell is a non-hybrid flow cell. In one embodiment of the aqueous redox flow cell, the negolyte comprises sodium cations and transition metal chelate anions. In one embodiment of the aqueous redox flow cell, the transition metal chelate anions are chromium chelate anions. In one embodiment of the aqueous redox flow cell, the transition metal chelate anions comprise a chelate of chromium and an aminopolycarboxylic acid. In one embodiment of the aqueous redox flow cell, the transition metal chelate anions comprise a chelate of chromium and propylenediamine tetra-acetic acid.

In one embodiment of the aqueous redox flow cell, the negolyte is alkaline. In one embodiment of the aqueous redox flow cell, the posolyte is alkaline. In one embodiment of the aqueous redox flow cell, the posolyte has a pH of 8 or greater. In one embodiment of the aqueous redox flow cell, the posolyte has a pH of 10 or greater. In one embodiment of the aqueous redox flow cell, the posolyte has a pH of 12 or greater. In one embodiment of the aqueous redox flow cell, the posolyte has a pH of 14 or greater. In one embodiment of the aqueous redox flow cell, the posolyte is acidic. In one embodiment of the aqueous redox flow cell, the posolyte has a pH of 0 or greater. In one embodiment of the aqueous redox flow cell, the posolyte has a pH of 1 or greater. In one embodiment of the aqueous redox flow cell, the posolyte has a pH of 2 or greater. In one embodiment of the aqueous redox flow cell, the posolyte has a pH of 4 or greater. In one embodiment of the aqueous redox flow cell, the posolyte has a pH of 5 or greater. In one embodiment of the aqueous redox flow cell, the posolyte has a pH of 6 or greater.

In one embodiment of the aqueous redox flow cell, the posolyte comprises a tris(bipyridyl) iron complex.

In another aspect, the present disclosure provides an ion-exchange membrane comprising:
a ceramic material having Formula (II):

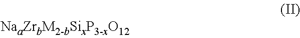

wherein M is selected from the group consisting of Mg, Ca, Sc, Yb, Co, Zn, La, Ce, and mixtures thereof,
wherein a is between 1 and 6, and
wherein b is between 1 and 2, and
wherein x is between 0 and 3, and
wherein the ceramic material has an area % of a glassy phase of less than 15% when determined using scanning electron microscopy imaging analysis. In one embodiment of the ion-exchange membrane, M is Mg. In one embodiment of the ion-exchange membrane, the ceramic material has a relative density of greater than 95%.

In one embodiment of the ion-exchange membrane, the area % of the glassy phase is less than 10% when determined using scanning electron microscopy imaging analysis. In one embodiment of the ion-exchange membrane, the area % of the glassy phase is less than 5% when determined using scanning electron microscopy imaging analysis. In one embodiment of the ion-exchange membrane, the area % of the glassy phase is less than 3% when determined using scanning electron microscopy imaging analysis. In one embodiment of the ion-exchange membrane, the ceramic material has an area % of a ZrO₂ phase of less than 5% when determined using scanning electron microscopy imaging analysis. In one embodiment of the ion-exchange membrane, the area % of the ZrO₂ phase is less than 3% when determined using scanning electron microscopy imaging analysis. In one embodiment of the ion-exchange membrane, the ceramic material has an area % of grains of greater than 80% when determined using scanning electron microscopy imaging analysis.

In one embodiment of the ion-exchange membrane, the ceramic material has an area % of grains of greater than 90% when determined using scanning electron microscopy imaging analysis. In one embodiment of the ion-exchange membrane, the ceramic material has an area % of grains of greater than 95% when determined using scanning electron microscopy imaging analysis.

These and other features, aspects, and advantages of the present invention will become better understood upon consideration of the following detailed description, drawings, and appended claims.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is a schematic of a non-limiting example of a redox flow cell in which an ion-exchange membrane according to one embodiment of the present disclosure can be used.

FIG. 1A shows: in Panel (a), Process flow diagram for fabrication of NZSP_{SA-SSR}. TEOS=Si(OC₂H₅)₄, and in Panel (b), XRD patterns, and in Panel (c), SEM images of the polished surfaces of NZSP_{SA-SSR} and NZSP_{COMM} pellets (*=ZrO₂).

FIG. 2 shows SEM images of an NZSP_{COMM} pellet in Panel (a) its pristine state and after immersion for four days in Panel (b) deionized water, in Panel (c) 1 M NaMnO₄ in 3 M NaOH, and in Panel (d) 1 M NaCl. Pores in Panel (b), (c) and (d) are indicated. SEM images of a NZSP_{SA-SSR} pellet in Panel (e) its pristine state and after immersion for four days in Panel (f) deionized water, in Panel (g) 1 M NaMnO₄ in 3 M NaOH and in Panel (h) 1 M NaCl.

FIG. 3 shows ICP-MS measurements of concentrations of Zr, Na, P, and Si in deionized water and 1 M NaCl into which NZSP_{COMM} and NZSP_{SA-SSR} pellets were immersed for four days. The “no sample” was the starting deionized water (with no pellet immersion).

FIG. 4 shows Nyquist plots from EIS spectra of symmetric Na₄Fe(CN)₆/Na₃Fe(CN)₆ flow cells containing in Panel (a) NZSP_{COMM} and in Panel (b) NZSP_{SA-SSR} pellets. The electrolyte comprised 0.05 M Na₄Fe(CN)₆ and 0.05 M Na₃Fe(CN)₆ in a supporting electrolyte of 0.066 M NaOH. In Panel (c) Total resistance (Rₜₒₜ) and high-frequency series resistance (RHF) for NZSP_{COMM} and NZSP_{SA-SSR} cells over time as estimated from fits to the equivalent circuits in FIG. 12.

FIG. 5 shows cycling of Zn—MnO₄ redox-flow cells with NZSP_{SA-SSR} and Nafion™ membranes. In Panels (a, c) Charge capacity, discharge capacity, and Coulombic efficiency vs time of cells containing Nafion™ 117 and NZSP_{SA-SSR} membranes and in Panels (b,d) voltage profiles of selected cycles for the cycling of 5 mL 0.18 M Na₂MnO₄ vs 10 mL 0.25 M Na₂Zn(OH)₄.

FIG. 6 shows cycling of a CrPDTA-MnO₄ redox-flow cell with NZSP_{SA-SSR} membrane for four days. The negolyte was 25 mL of 0.05 M NaCrPDTA and the capacity-limiting posolyte comprised 5 mL of 0.05 M Na₂MnO₄. In Panel (a) Charge capacity, discharge capacity, and Coulombic efficiency vs number of cycles. In Panel (b) Voltage profiles of selected cycles. The sudden drop in capacity for cycle 26 was due to momentary oxygen contamination in the glovebox.

FIG. 7 shows demonstrated open-circuit voltage and high-frequency area-specific conductance (inverse of area-specific resistance) for literature-reported aqueous redox-flow cells and our Example using NaSICON membranes. Hybrid configurations are denoted with diamond-shaped symbols (♦). More details for literature-reported cells are provided in Table S5.

FIG. 8 shows SEM images of NZSP_{COMM} and NZSP_{SA-SSR} in Panels (a,c) pristine condition and after in Panels (b,d) four-day immersion in 1 M NaOH.

FIG. 9 shows SEM micrographs in Panels (a,c,e) and confocal images in Panels (b, d, f) of NZSP_{SA-SSR}, in Panels (a,b) in pristine condition and after immersion for one day in Panels (c,d) 1 M NaCl and in Panels (e,f) 1 M KCl. Arithmetical mean height (SA) is indicated on the confocal images and used to evaluate and compare the surface roughness of the NaSICON pellet before and after soaking.

FIG. 10 shows XRD of NaSICON before and after immersion in DI water. (•=ZrO₂)

FIG. 11 shows photographs of Panel (a) NZSP_{COMM} and Panel (b) NZSP_{SA-SSR} after immersion in 1 M KCl for one day. SEM images of Panel (c) pristine NZSP_{SA-SSR} and Panel (d) after immersion in 1 M KCl for a day.

FIG. 12 shows equivalent circuits used to fit the Nyquist plots from symmetric Na₄Fe(CN)₆/Na₃Fe(CN)₆ flow cells containing in Panel (a) NZSP_{COMM} and in Panel (b) NZSP_{SA-SSR} pellets.

FIG. 13 shows UV-vis spectra of cycled (black) and uncycled (red) Na₂MnO₄ posolyte compared to NaMnO₄. The cycled Na₂MnO₄ solution in the Zn—MnO₄ cell shows conversion to NaMnO₄ (indicating imbalance) without significant loss of concentration (as shown by the isosbestic point seen from the absorbance at 571 nm).

FIG. 14 shows Nyquist plots from the EIS data of Panel (a) Zn—MnO₄ and Panel (b) CrPDTA-MnO₄ full cells with a geometric area of 1.8 cm².

### DETAILED DESCRIPTION OF THE INVENTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Numeric ranges disclosed herein are inclusive of their endpoints. For example, a numeric range of between 1 and 10 includes the values 1 and 10.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. Skilled artisans will recognize the examples provided herein have many useful alternatives and fall within the scope of embodiments of the invention.

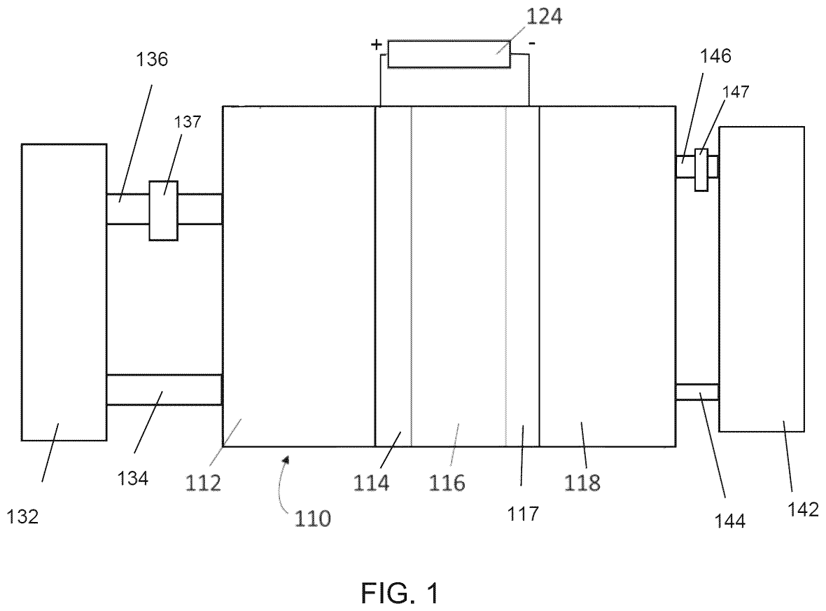

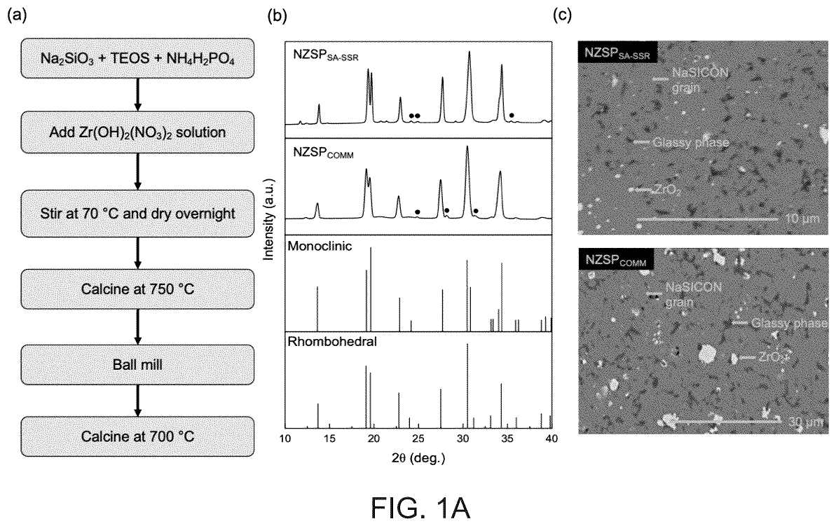

FIG. 1 shows a non-limiting example of an aqueous redox flow cell 110 in which an ion-exchange membrane according to one embodiment of the present disclosure can be used. FIG. 1 is not necessarily drawn to scale. Although only one cell is shown, a plurality of the cells can be electrically connected in a multi-cell battery. The aqueous redox flow cell 110 includes a posolyte compartment 112, a positive electrode 114, an ion-exchange membrane 116, a negative electrode 117, and a negolyte compartment 118. The positive electrode 114 and the negative electrode 117 of the flow cell 110 may be in electrical communication (optionally via current collectors) with an electrical component 124. The electrical component 124 could place the cell 110 in electrical communication with an electrical load that discharges the cell or a charger that charges the cell (e.g., photovoltaic sources and/or wind turbines). As electrons flow from the negolyte compartment 118 to the posolyte compartment 112 through the electrical component 124 during discharge, or flow from the posolyte compartment 112 to the negolyte compartment 118 through the electrical component 124 during charge, ions migrate across the ion-exchange membrane 116 to balance the flow of electrons and maintain charge neutrality of the negolyte compartment 118 and the posolyte compartment 112. The ions that migrate across the ion-exchange membrane 116 can vary depending on the chemistry of the cell. Non-limiting example ions that migrate across the ion-exchange membrane 116 include H⁺, OH⁻, and metal cations (e.g., zinc cations).

The aqueous redox flow cell 110 includes a posolyte reservoir 132 in fluid communication with the posolyte compartment 112 via a posolyte outlet conduit 134 and a posolyte inlet conduit 136. A posolyte pump 137 circulates a posolyte in the posolyte compartment 112. The aqueous redox flow cell 110 also includes a negolyte reservoir 142 in fluid communication with the negolyte compartment 118 via a negolyte outlet conduit 144 and a negolyte inlet conduit 146. A negolyte pump 147 circulates a negolyte in the negolyte compartment 118.

In one non-limiting example embodiment of the aqueous redox flow cell 110, the flow cell is a hybrid flow cell. In another non-limiting example embodiment of the aqueous redox flow cell 110, the flow cell is a non-hybrid flow cell.

In one non-limiting example embodiment of the aqueous redox flow cell 110, the positive electrode 114 and the negative electrode 117 each comprise a carbon-containing material (e.g., graphite). In one non-limiting example embodiment of the aqueous redox flow cell 110, the posolyte comprises Na₂MnO₄. In one embodiment, the posolyte is alkaline. In one embodiment, the posolyte has a pH of 8 or greater. In one embodiment, the posolyte has a pH of 10 or greater. In one embodiment, the posolyte has a pH of 12 or greater. In one embodiment, the posolyte has a pH of 14 or greater. In one embodiment of the aqueous redox flow cell, the posolyte is acidic. In principle, the posolyte can be quite acidic (pH 0) if the membrane can be made stable enough (e.g., by protecting it with a coating of TiO₂ or alumina). This will enable cell voltage of up to 3 V. In one embodiment of the aqueous redox flow cell, the posolyte has a pH of 0 or greater. In one embodiment of the aqueous redox flow cell, the posolyte has a pH of 1 or greater. In one embodiment of the aqueous redox flow cell, the posolyte has a pH of 2 or greater. In one embodiment of the aqueous redox flow cell, the posolyte has a pH of 4 or greater. In one embodiment of the aqueous redox flow cell, the posolyte has a pH of 5 or greater. In one embodiment of the aqueous redox flow cell, the posolyte has a pH of 6 or greater.

In one non-limiting example embodiment of the aqueous redox flow cell 110, the negolyte comprises sodium cations and zinc-containing anions. In one embodiment, the zinc-containing anions comprise tetrahydroxozincate anions. In one embodiment, the negolyte comprises sodium cations and transition metal chelate anions. In one embodiment, the transition metal chelate anions are chromium chelate anions. In one embodiment, the transition metal chelate anions comprise a chelate of chromium and an aminopolycarboxylic acid. In one embodiment, the transition metal chelate anions comprise a chelate of chromium and propylenediamine tetra-acetic acid. In one embodiment, the negolyte is alkaline. In one embodiment, the negolyte has a pH of 8 or greater. In one embodiment, the negolyte has a pH of 10 or greater. In one embodiment, the negolyte has a pH of 12 or greater.

In one non-limiting example embodiment of the aqueous redox flow cell 110, the ion-exchange membrane 116 comprises a ceramic material having Formula (I):

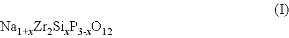

wherein x is between 0 and 3, and wherein the ceramic material has an area % of a glassy phase of less than 15% when determined using scanning electron microscopy imaging analysis. In one embodiment, x is between 2 and 3. In one embodiment, the ceramic material has the formula: Na_{3.4}Zr₂Si_{2.4}P_{0.6}O₁₂.

In another embodiment, the area % of the glassy phase is less than 10% when determined using scanning electron microscopy imaging analysis. In another embodiment, the area % of the glassy phase is less than 5% when determined using scanning electron microscopy imaging analysis. In another embodiment, the area % of the glassy phase is less than 3% when determined using scanning electron microscopy imaging analysis.

In one embodiment, the ceramic material has an area % of a ZrO₂ phase of less than 5% when determined using scanning electron microscopy imaging analysis. In another embodiment, the area % of the ZrO₂ phase is less than 3% when determined using scanning electron microscopy imaging analysis.

In one embodiment, the ceramic material has an area % of grains of greater than 80% when determined using scanning electron microscopy imaging analysis. In another embodiment, the ceramic material has an area % of grains of greater than 90% when determined using scanning electron microscopy imaging analysis. In another embodiment, the ceramic material has an area % of grains of greater than 95% when determined using scanning electron microscopy imaging analysis.

In one embodiment, the ceramic material exhibits no observable microstructural changes as indicated by scanning electron microscopy after immersion in 1 M KCl for 24 hours.

In one embodiment, the ceramic material comprises a mixture of rhombohedral and monoclinic phases.

In one non-limiting example embodiment of the aqueous redox flow cell 110, the flow cell has an open-circuit voltage greater than 1.5 V. In another embodiment, the flow cell has an open-circuit voltage greater than 1.6 V. In another embodiment, the flow cell has an open-circuit voltage greater than 1.8 V. In another embodiment, the flow cell has an open-circuit voltage of at least 1.9 V. In another embodiment, the flow cell has an open-circuit voltage of at least 2.0 V.

In one non-limiting example embodiment of the aqueous redox flow cell 110, the flow cell has flow cell has an area-specific conductance greater than 0.02 ohm⁻¹ cm⁻². In another embodiment, the flow cell has an area-specific conductance greater than 0.03 ohm⁻¹ cm⁻². In another embodiment, the flow cell has an area-specific conductance greater than 0.04 ohm⁻¹ cm⁻². In another embodiment, the flow cell has an area-specific conductance greater than 0.05 ohm⁻¹ cm⁻². In one embodiment of the aqueous redox flow cell, the flow cell has an area-specific conductance greater than 0.001 ohm⁻¹ cm⁻². In one embodiment of the aqueous redox flow cell, the flow cell has an area-specific conductance greater than 0.01 ohm⁻¹ cm⁻². In one embodiment of the aqueous redox flow cell, the flow cell has an area-specific conductance in a range of 0.001 ohm⁻¹ cm⁻² to 0.06 ohm⁻¹ cm⁻². In one embodiment of the aqueous redox flow cell, the flow cell has an area-specific conductance in a range of 0.02 ohm⁻¹ cm⁻² to 0.06 ohm⁻¹ cm⁻².

In another non-limiting example embodiment of the aqueous redox flow cell 110, the ion-exchange membrane 116 comprises a ceramic material having Formula (II) wherein Zr as in Formula (I) can be partially replaced by other ions (e.g., Mg, Ca, Sc, Yb, Co, Zn, La, and Ce) to increase conductivity, In this embodiment, the ion-exchange membrane comprises a ceramic material having Formula (II):

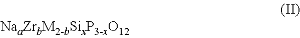

wherein M is selected from the group consisting of Mg, Ca, Sc, Yb, Co, Zn, La, Ce, and mixtures thereof,
wherein a is between 1 and 6, and
wherein b is between 1 and 2, and
wherein x is between 0 and 3, and
wherein the ceramic material has an area % of a glassy phase of less than 15% when determined using scanning electron microscopy imaging analysis. In one embodiment of the ion-exchange membrane, M is Mg. In one embodiment of the ion-exchange membrane, the ceramic material has a relative density of greater than 95%.

In one embodiment of the ion-exchange membrane, the area % of the glassy phase is less than 10% when determined using scanning electron microscopy imaging analysis. In one embodiment of the ion-exchange membrane, the area % of the glassy phase is less than 5% when determined using scanning electron microscopy imaging analysis. In one embodiment of the ion-exchange membrane, the area % of the glassy phase is less than 3% when determined using scanning electron microscopy imaging analysis. In one embodiment of the ion-exchange membrane, the ceramic material has an area % of a ZrO₂ phase of less than 5% when determined using scanning electron microscopy imaging analysis. In one embodiment of the ion-exchange membrane, the area % of the ZrO₂ phase is less than 3% when determined using scanning electron microscopy imaging analysis. In one embodiment of the ion-exchange membrane, the ceramic material has an area % of grains of greater than 80% when determined using scanning electron microscopy imaging analysis.

In one embodiment of the ion-exchange membrane, the ceramic material has an area % of grains of greater than 90% when determined using scanning electron microscopy imaging analysis. In one embodiment of the ion-exchange membrane, the ceramic material has an area % of grains of greater than 95% when determined using scanning electron microscopy imaging analysis.

The present invention also provides a method for making an ion-exchange membrane. In one embodiment, the method comprises: (a) combining a first solid comprising sodium, a second solid comprising silicon, and a third solid comprising phosphorus to form a first mixture; (b) adding a solution of a zirconium-containing compound to the first mixture to create a second mixture; (c) heating the second mixture at a temperature in a range of 30° C. to 100° C. and drying to form a powder; and (d) applying simultaneous heat and pressure to the powder to form an ion-exchange membrane comprising a ceramic material having a Formula (I):

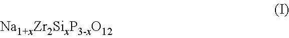

wherein x is between 0 and 3. In one embodiment, x is between 2 and 3.

In one embodiment of the method, the ceramic material has an area % of a glassy phase of less than 15% when determined using scanning electron microscopy imaging analysis. In another embodiment of the method, the ceramic material has an area % of a glassy phase of less than 10% when determined using scanning electron microscopy imaging analysis. In another embodiment of the method, the ceramic material has an area % of a glassy phase of less than 5% when determined using scanning electron microscopy imaging analysis. In another embodiment of the method, the ceramic material has an area % of a ZrO₂ phase of less than 5% when determined using scanning electron microscopy imaging analysis. In another embodiment of the method, the ceramic material has an area % of grains of greater than 80% when determined using scanning electron microscopy imaging analysis.

In one embodiment of the method, step (d) comprises using a hot-pressing technique. In one embodiment of the method, the hot-pressing technique uses at least one of induction heating, indirect resistance heating, or direct hot-pressing. In one embodiment of the method, step (d) comprises using rapid-induction hot-pressing. In one embodiment of the method, the heat is applied at a temperature in a range of 1000° C. to 1400° C. In another embodiment of the method, the heat is applied at a temperature in a range of 1200° C. to 1300° C. In another embodiment of the method, the pressure applied is between 5 and 80 MPa. In another embodiment of the method, the pressure applied is between 20 and 40 MPa.

In one embodiment of the method, the first solid comprises a sodium salt. In one embodiment of the method, the first solid comprises sodium metasilicate. In one embodiment of the method, the second solid comprises an alkyl silicate. In one embodiment of the method, the second solid comprises tetraethyl orthosilicate. In one embodiment of the method, the third solid comprises a phosphate. In one embodiment of the method, the third solid comprises ammonium dihydrogen phosphate. In one embodiment of the method, the zirconium-containing compound comprises a zirconium salt. In one embodiment of the method, the zirconium-containing compound comprises zirconium hydroxide nitrate.

In one embodiment of the method, the ceramic material has a relative density above 95%. In one embodiment of the method, step (c) further comprises calcining the powder. In one embodiment of the method, the calcining occurs at a temperature in a range of 600° C. to 800° C. In one embodiment of the method, step (a) comprises combining the first solid, the second solid, and the third solid in an aqueous solvent.

In a non-limiting example of embodiment of the present invention, we have developed redox-flow cells that contain ceramic ion conductors which are stable to a range of pH-neutral to strongly alkaline electrolytes and selective for Na-ion transport. Because these ion conductors are fully dense, they can enable cycling of charge-storing electrolytes at disparate pH values. We have shown cycling of a 1.7 V battery constituted by a slightly alkaline negative electrolyte containing a chromium complex and a strongly alkaline positive electrolyte based on sodium permanganate. To our knowledge, this is the highest-voltage aqueous non-hybrid flow battery subjected to long-term cycling with a single membrane, and we project that 2.0 V systems may be achieved with other chemistries. For example, another high-potential posolyte material we are exploring is a tris(bipyridyl) iron complex, which has a high enough potential to make a 2.0 V battery against CrPDTA⁻. Other high-voltage organic/organometallic species can be used as posolyte materials. Any charge-storing materials that operate between pH 7 and 14.5 should be appropriate. For example, the organometallic complex can include an active redox species such as sodium, iron, manganese, cobalt, titanium, and chromium. Complexing a metal active redox species with various organometallics can increase solubility of the active redox species in a solvent.

### EXAMPLE

The following Example has been presented in order to further illustrate the invention and is not intended to limit the invention in any way. The statements provided in the Example are presented without being bound by theory.

### 1. Overview of the Example

Sodium superionic conductors (NaSICONs) have garnered considerable attention as ion-exchange membranes in aqueous redox-flow batteries because they can eliminate crossover-induced capacity fade. Two challenges to their practical use are microstructural instability in aqueous solutions and low total conductivity (≤1 mS/cm at room temperature), which causes high cell resistance.

In this Example, we evaluate the potential for NaSICON synthesized via a solution-assisted solid-state reaction (NZSP_{SA-SSR}) to address these challenges. Upon immersion in a series of neutral-pH to strongly alkaline electrolytes, NZSP_{SA-SSR} pellets show a more stable impedance and microstructure over time than conventional NaSICON (NZSP_{COMM}) pellets. We observe prominent etching of the glassy phase in NZSP_{COMM} whereas the glassy phase in NZSP_{SA-SSR} is negligible, and NZSP_{SA-SSR} pellets show no significant change in microstructure even when exposed to solutions with high (˜1 M) concentrations of K⁺ ions and strongly oxidizing NaMnO₄. We assembled a 1.9 V Zn—MnO₄ flow cell containing a NZSP_{SA-SSR} membrane, and it demonstrated cycling stability for close to 100 hours. NZSP_{SA-SSR} also shows promise for accommodating other high-voltage cell chemistries, such as a pH-decoupled NaCrPDTA-NaMnO₄ system with an open-circuit potential of 1.65 V.

### 2. Introduction

Redox-flow batteries (RFBs) are a promising technology for low-cost, long-duration storage of electricity and thereby for encouraging widespread use of intermittently available renewable (e.g., solar and wind) power [Ref. 1]. Their design differs from enclosed, conventional (e.g., Li-ion) batteries in that energy storage and power conversion are decoupled: energy is stored in a pair of separate electrolytes that contain redox-active molecular/ionic charge carriers, whereas power conversion occurs via redox reactions involving these carriers in an electrochemical cell. At high ratios of energy to power, or long discharge durations at rated power, the overall cost of the system approaches the chemical cost of the electrolytes [Ref. 2]. Recent techno-economic analyses suggest that system costs of RFBs need to be lower than 50 $/kWh [Ref. 3-5], and perhaps <20 $/kWh [Ref. 5, 6] to ensure their commercial viability for long-duration applications. For the levelized cost of electricity delivered by RFBs to be competitively low, the charge carriers should be stable and should not cross over from one electrolyte to the other through the membrane in the electrochemical cell [Ref. 7]. Crossover may lead to irreversible capacity loss during cycling of an RFB, as has been observed in flow cells containing permanganate-based and polysulfide-based charge carriers and polymer membranes [Ref. 8].

Ceramic ion conductors (CICs) can eliminate such crossover in RFBs and still function effectively as ion-exchange membranes due to their high relative densities (>95%) and close-to-unity transference numbers for specific ions (e.g., Li⁺ or Na⁺). A well-studied CIC membrane for RFBs is NaSICON (Na Super Ionic Conductor), which has the chemical formula Na₁₊ₓZr₂SiₓP₃₋ₓO₁₂ with 0<x<3 [Ref. 9-15]. NaSICON is promising for use in aqueous RFBs as it is macroscopically stable in water [Ref. 16] and has a bulk conductivity at room temperature of up to 15 mS/cm for Na₃Zr₂Si₂PO₁₂ [Ref. 17]. It is conventionally synthesized via a high-temperature, solid-state route [Ref. 18-20]. This method is energy intensive and results in a complex microstructure comprising multiple phases: (1) micron-scale crystalline grains with a monoclinic or rhombohedral structure, (2) an amorphous/glassy phase between grains comprising Na, Si and Zr, and (3) ZrO₂. Past studies have demonstrated that the glassy phase is susceptible to etching in water [Ref. 21, 22]. We have shown recently that for Na_{3.1}Zr_{1.55}Si_{2.3}P_{0.7}O₁₁, this etching is exacerbated when K⁺ is present in the electrolyte, leading to growth in the grain boundary impedance and, for sufficiently high [K⁺], complete disintegration of the membrane [Ref. 22]. Others have observed that NaSICON undergoes similar disintegration in acidic media [Ref. 23]. The breakdown of the glassy phase is understood to originate from some combination of a higher intrinsic solubility in water and ion exchange between Na⁺ in the solid and other cations (e.g., H⁺ or K⁺) in solution, which induces a structural instability due to size mismatch.

We show in this Example that NaSICON's interfacial stability can be significantly improved by minimizing the fraction of glassy phase present in its microstructure. We achieve this by a solution-assisted solid-state reaction (SA-SSR) for NaSICON powder synthesis [Ref. 24] with pellet fabrication using hot pressing. This approach significantly reduces the glassy phase fraction in the microstructure compared to NaSICON synthesized using conventional sintering, as recently described by Kimura et al. [Ref. 25]. Electrochemical impedance spectroscopy, mass spectrometry, and electron microscopy reveal that SA-SSR NaSICON has a greater microstructural stability and greater electrochemical stability than conventional NaSICON upon immersion in neutral-pH to strongly alkaline electrolytes containing Na⁺ and K⁺. A 1.9 V Zn—MnO₄ hybrid flow cell that was capacity-limited by NaMnO₄ and contained SA-SSR NaSICON had an area-specific resistance of 18 Ω-cm⁻² at room temperature and showed no capacity fade for close to 100 hours of cycling. By contrast, a nominally identical flow cell with a Nafion™ membrane exhibited crossover-induced capacity fade at ˜2%/day. We also cycled a 1.7 V pH-decoupled flow cell with a NaMnO₄ posolyte and negolyte based on sodium-1,3-propylenediaminetetraacetato chromate (Ill) complex (NaCrPDTA) [Ref. 26]. Based on chemical cost alone, RFBs that use NaSICON, Zn, NaCrPDTA and NaMnO₄ are expected to be inexpensive, with system costs ranging between 1.5 and ˜26 $/kWh. Our Example demonstrates that judicious engineering of the microstructure of CICs can enable inexpensive but durable high-voltage RFB systems for long-duration energy storage.

### 3. Results and Discussion

### NaSICON Synthesis and Characterization

We synthesized NaSICON powder using an SA-SSR method (FIG. 1A Panel a) in which Na₂SiO₃, NH₄H₂PO₄ and Zr(OH)₂(NO₃)₂ in a molar ratio of 2.83:1:3.33 reacted in aqueous solution at 70° C. This temperature is very low relative to the temperatures applied in conventional, all-solid-state methods for NaSICON synthesis, where precursor powders can only react at temperatures above 1200° C. [Ref. 27]. Because the synthesis takes place at low temperature and in solution, it is likely to be less energy-intensive and more scalable than high-temperature solid-state routes. The Zr can be partially replaced by other ions (e.g., Mg, Ca, Sc, Yb, Co, Zn, La and Ce) in the NaSICON powder to increase conductivity by including a nitrate of any of Mg, Ca, Sc, Yb, Co, Zn, La and Ce in place of some of the Zr(OH)₂(NO₃)₂. We fashioned SA-SSR NaSICON powder into dense millimeter-thin pellets via calcination at 700° C. followed by rapid induction heating and simultaneous application of pressure (i.e., rapid induction hot pressing) at 1225° C. and 30 MPa to achieve samples of high relative density (>95%). Pellets were also fabricated from commercially procured Na₃Zr₂Si₂PO₁₂ powder that was synthesized via the conventional all-solid-state route. The sintered SA-SSR and commercial pellets had nominal compositions of Na_{3.4}Zr₂Si_{2.4}P_{0.6}O₁₂ and Na₃Zr₂Si₂PO₁₂, respectively, and are hereafter denoted by NZSP_{SA-SSR} and NZSP_{COMM}.

XRD measurements (FIG. 1A Panel b) were conducted on hot-pressed NZSP_{COMM} and NZSP_{SA-SSR} pellets to assess their purity. The XRD pattern for the NZSP_{COMM} pellet largely aligns with the reference for rhombohedral NaSICON but with trace amounts of ZrO₂. A small amount of ZrO₂ was also present in the NZSP_{SA-SSR} pellet. Nevertheless, its XRD peaks at 28=17, 18 and 33.5⁰ indicated that NZSP_{SA-SSR} comprised a mixture of rhombohedral and monoclinic NaSICON phases.

Backscattered scanning electron microscopy (SEM) imaging (FIG. 1A Panel c) revealed that in addition to NaSICON (light grey) and ZrO₂ (white), NZSP_{COMM} and NZSP_{SA-SSR} contained an amorphous phase (dark grey), which has been previously reported [Ref. 28]. Virtually no pores were visible in both samples, indicating a close-to-unity relative density owing to the pressure-assisted densification. One significant difference between the microstructure of NZSP_{COMM} and NZSP_{SA-SSR} is that NZSP_{SA-SSR} had much smaller grains than NZSP_{COMM} (Table S1). Because our previous work has shown that the glassy phase of NaSICON is susceptible to etching in aqueous electrolytes [Ref. 22], we surmised that the smaller grains and the less extensive/prominent glassy phase network in NZSP_{SA-SSR} may predispose it to higher microstructural stability in aqueous electrolytes than NZSP_{COMM}.

TABLE S1
Image Analysis of Commercial and SA-SSR NaSICON.

| | Commercial (area %) | SA-SSR (area %) |
|---|---|---|
| Glass | 15.6% | 1.7% |
| ZrO₂ | 7.0% | 1.6% |
| Grain | 77.5% | 96.8% |

### Microstructural and Electrochemical Stability

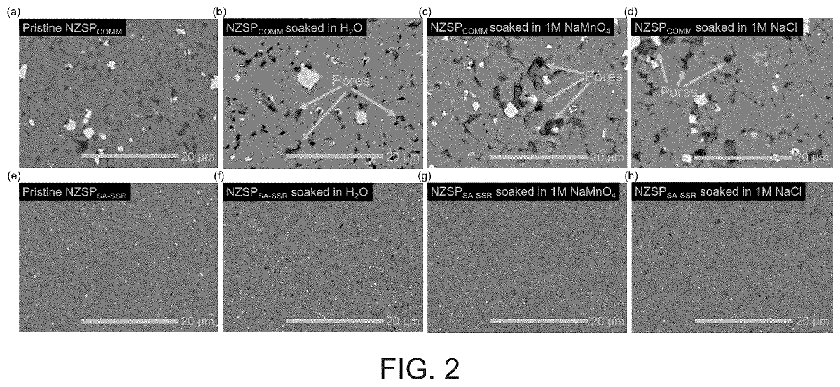

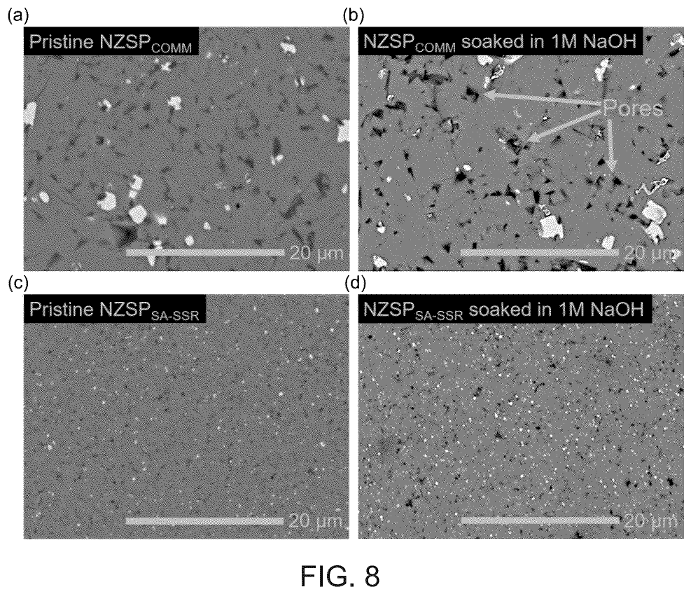

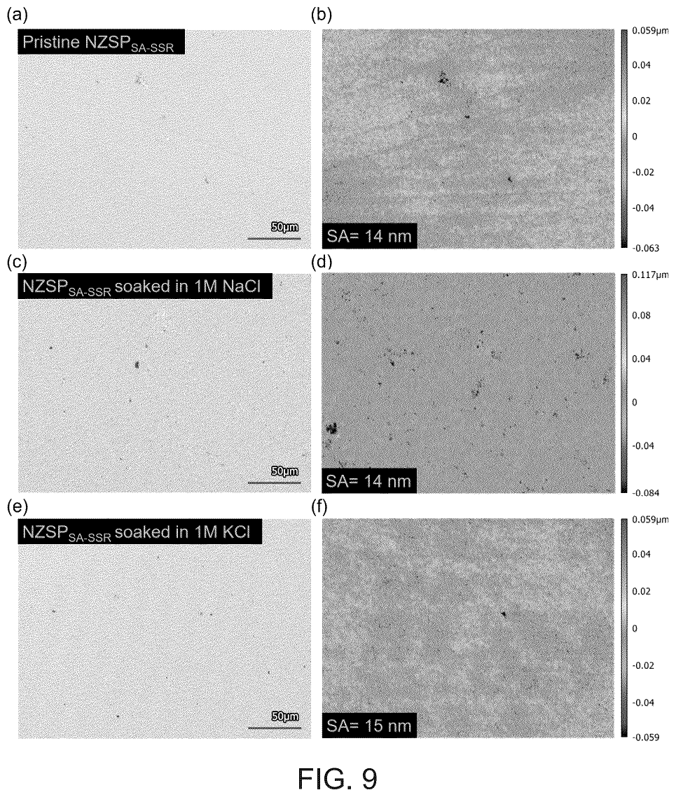

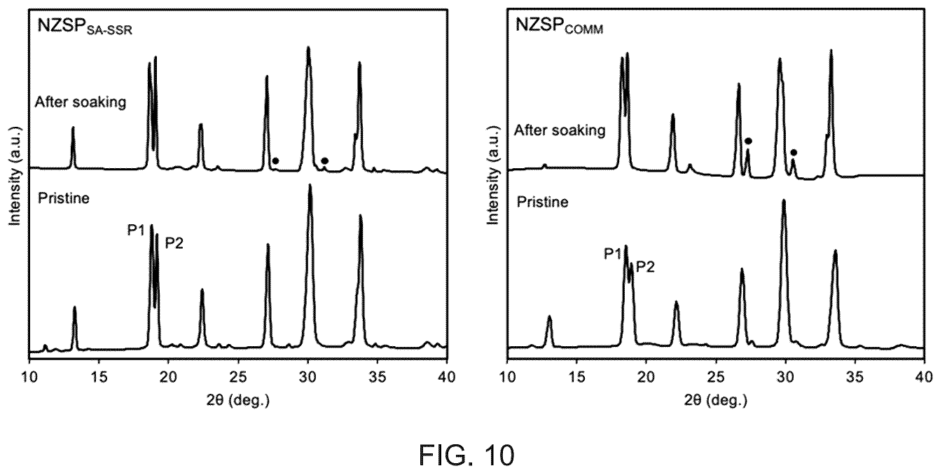

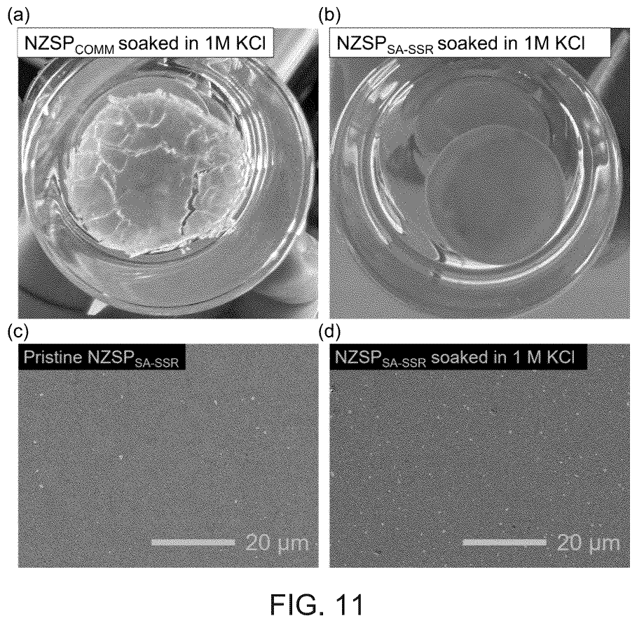

To test this hypothesis, we imaged by SEM NZSP_{COMM} and NZSP_{SA-SSR} pellets before and after immersion in deionized water, 1 M NaCl, 3 M NaOH, and 1 M NaMnO₄ in 3 M NaOH. 1 M NaCl and 3 M NaOH were chosen because they represent pH limits within which most non-acidic aqueous organic redox-flow cells are tested. NaMnO₄ was selected because it is a better posolyte material than the commonly used ferrocyanide (Fe(CN)₆) in terms of redox potential (0.558 vs 0.358 V vs standard hydrogen electrode [SHE]), solubility (3.62 M [Ref. 29] vs 0.56 M [Ref. 30] for Na₄Fe(CN)₆), and cost (1.49 vs 36.1 $/kAh, see Table S2 and Table S3). Over the course of four days, NZSP_{COMM} pellets soaked in deionized water (FIG. 2 Panel b), 1 M NaMnO₄ in 3 M NaOH (FIG. 2 Panel c), 1 M NaCl (FIG. 2 Panel d) and 3 M NaOH (FIG. 8 Panel b) developed micron-sized pores at grain boundaries and within the glassy phase, whereas the corresponding NZSP_{SA-SSR} pellets (FIG. 2 Panels f-h, FIG. 8 Panel d) exhibited negligible microstructural change relative to their pristine state. Confocal microscopy of NZSP_{SA-SSR} before and after immersion in 1 M NaCl (FIG. 9 Panels a-d) showed homogeneity in the surface topography, with a slightly rougher texture with tiny pinholes after immersion. XRD analysis (FIG. 10) of the NZSP_{SA-SSR} and NZSP_{COMM} pellets showed that immersing them into water causes an increase in the ratio of monoclinic to rhombohedral NaSICON but no other changes to their crystallinity. Although the glassy phase in NZSP_{COMM} is etched by the solutions mentioned above, the pellets do not disintegrate in them. Nevertheless, they disintegrate within 24 hours in 1 M KCl (FIG. 11 Panel a), in a similar manner as we showed for von Alpen NaSICON [Ref. 22]. These findings suggest that potassium ions likely induce structural collapse of the glassy phase by exchanging with smaller sodium ions. In contrast, NZSP_{SA-SSR} remains intact in 1 M KCl (FIG. 11 Panel b), with no observable microstructural changes as indicated by the SEM (FIG. 11 Panel d) and confocal (FIG. 9 Panels e and f) micrographs. These data confirm that the quantitatively negligible glassy phase content in NZSP_{SA-SSR} enhances its chemical and interfacial stability.

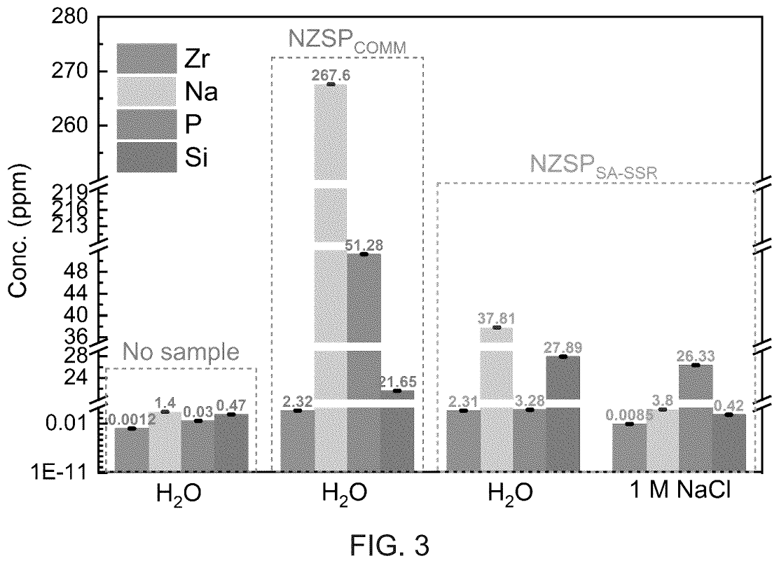

We measured the concentrations of Na, P, Si, and Zr in the deionized water and 1 M NaCl into which the pellets were immersed (FIG. 3) using inductively coupled plasma-mass spectrometry (ICP-MS). The results revealed that in deionized water, the sample containing NZSP_{COMM} shows a ˜7× higher [Na] of 268 ppm and a ˜15× higher [P] of 51.3 ppm than that containing NZSP_{SA-SSR} which had [Na] and [P] of 37.8 ppm and 3.28 ppm, respectively. This result is consistent with the more pronounced etching observed for the glassy phase in the NZSP_{COMM} (FIG. 2 Panel b) vs. NZSP_{SA-SSR} (FIG. 2 Panel f) pellet. Interestingly, [Si] and [Zr] were not higher in the NZSP_{COMM} than NZSP_{SA-SSR} immersed water: [Si] was slightly lower in NZSP_{COMM} (21.7 ppm in NZSP_{COMM} vs 27.9 ppm in NZSP_{SA-SSR}) and [Zr] was comparable in both samples (˜2.3 ppm). This preferential enrichment in Na and P is consistent with wavelength dispersive spectroscopy measurements of NZSP_{COMM}, which have revealed that its glassy phase is rich in Na and P [Ref. 31]. This observation is further corroborated by the data presented in Table S1, which indicates a significant concentration of the glassy phase in NZSP_{COMM}. Due to the significant glassy phase etching observed in NZSP_{COMM}-immersed deionized water, subsequent ICP-MS analysis was exclusively conducted on solutions into which NZSP_{SA-SSR} was immersed. A 1 M NaCl solution containing NZSP_{SA-SSR} exhibited negligible enrichment in [Si] and [Zr] relative to the deionized water control. Additionally, [Na] of 3.8 ppm (after correction for the 1 M [Na⁺] background) and a [P] of 26.3 ppm were detected, indicating that NaCl stabilizes the sodium in NZSP_{SA-SSR} structure, possibly through continuous fast reversible sodium ion exchange [Ref. 32] or sodium diffusion [Ref. 33]. The underlying mechanism for the slightly increased phosphorus etching remains unclear. It is additionally possible that NZSP_{SA-SSR} has a glassy phase with a different composition and a lower aqueous solubility than that in NZSP_{COMM}.

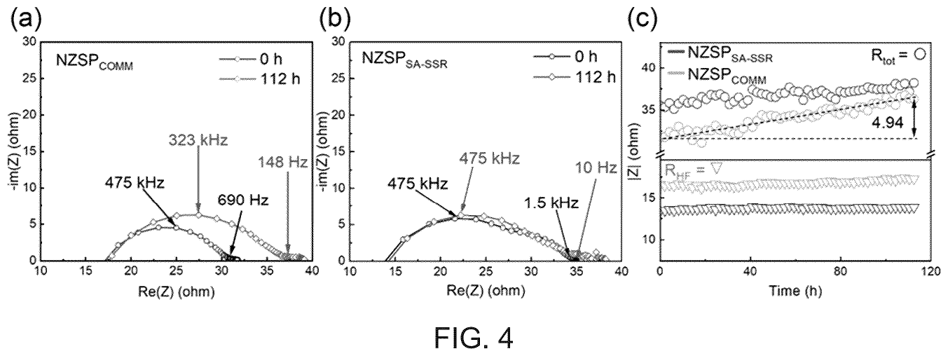

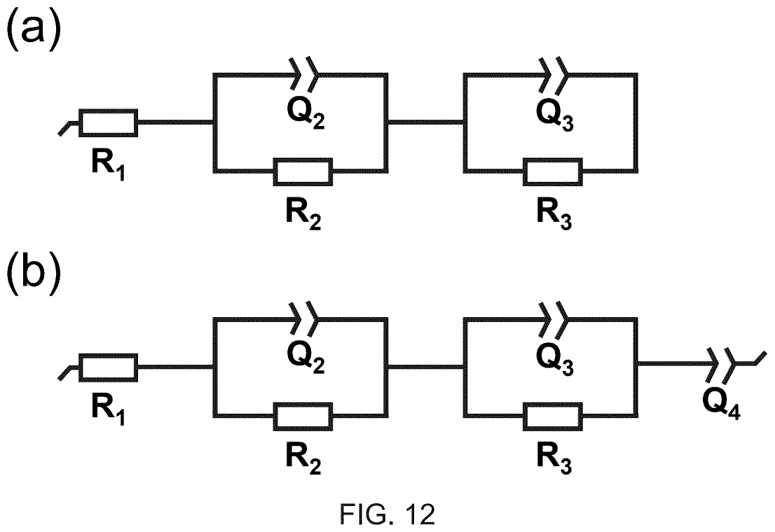

The greater microstructural stability of NZSP_{SA-SSR} relative to NZSP_{COMM} in aqueous electrolytes corresponded to a more stable electrochemical impedance over time (FIG. 4). This impedance was measured by integrating NZSP_{COMM} and NZSP_{SA-SSR} pellets into symmetric Na₄Fe(CN)₆/Na₃Fe(CN)₆ flow cells and taking intermittent electrochemical impedance spectroscopy (EIS) measurements over 112 hours. Over time, there was a clear increase in the diameter of the semicircular feature of the Nyquist plot for the NZSP_{COMM} cell (FIG. 4 Panel a), whereas the same feature for the NZSP_{SA-SSR} cell (FIG. 4 Panel b) showed virtually no change. We fit the EIS spectra from both cells to equivalent circuits (FIG. 12 and Table S4) and report the high-frequency resistance (RHF), which largely reflects the intra-grain resistance of the NaSICON pellet, and total resistance (Rₜₒₜ), which includes the grain boundary resistance, in FIG. 4 Panel c. Whereas RHF for both cells does not change significantly, Rₜₒₜ for the NZSP_{COMM} cell shows a greater increase than for the NZSP_{SA-SSR} cell, which reflects the trends in microstructural stability reported in FIG. 2.

### Flow Cell Cycling

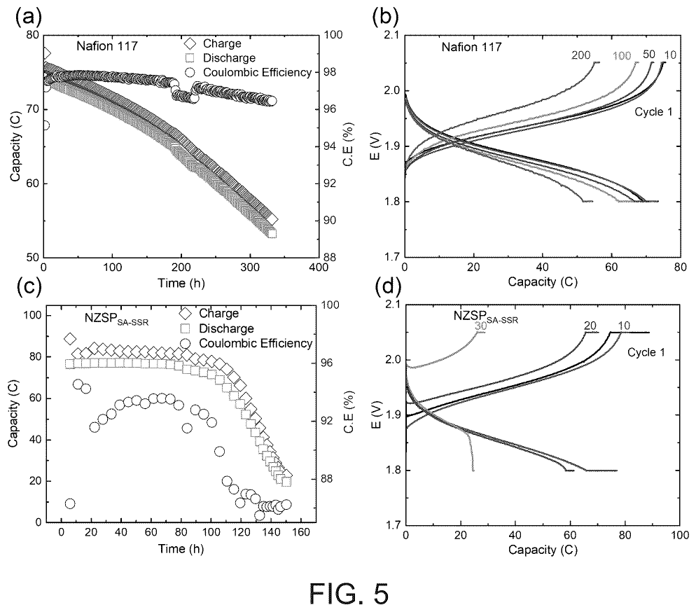

We cycled alkaline Zn—MnO₄ flow cells containing NZSP_{SA-SSR} and Nafion™ membranes at 5 mA/cm² and found that NZSP_{SA-SSR} effectively inhibited crossover-induced capacity fade, whereas Nafion™ did not (FIG. 5). The cells were capacity-limited by a posolyte comprising 0.18 M Na₂MnO₄ (sodium manganate) in 3 M NaOH; the non-capacity-limiting negolyte comprised 0.25 M Na₂Zn(OH)₄ (sodium zincate) in 4 M NaOH. The half-reactions expected in each cell and their standard redox potentials are:

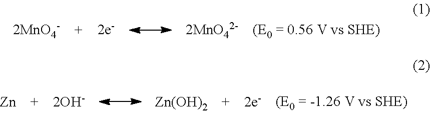

leading to the overall reaction:

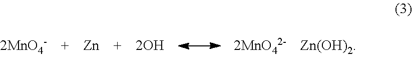

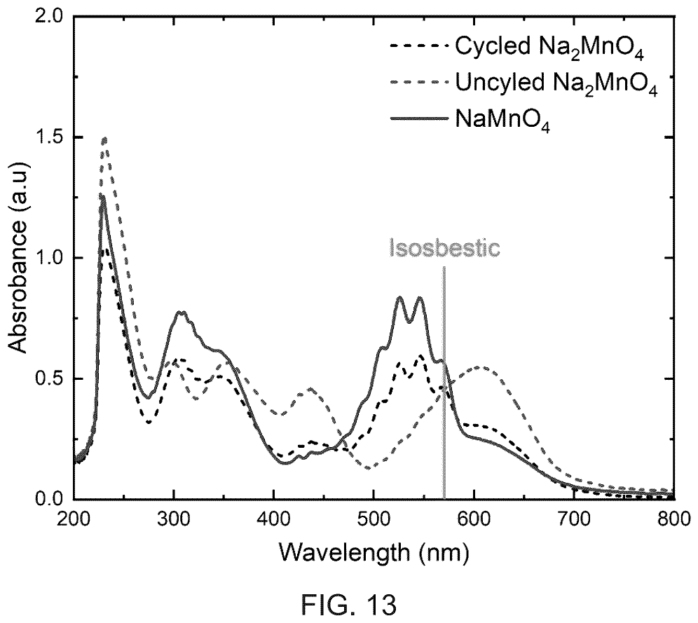

Both cells were cycled between 1.80 and 2.05 V using a constant-current, constant-voltage (CCCV) protocol to fully access the capacity of the NaMnO₄ electrolyte. The Nafion™ cell showed a rapid rate of capacity fade at an average of 1.9%/day over 350 hours; it also had an average Coulombic efficiency of 97% (FIG. 5 Panel a). Capacity fade can be attributed to crossover of the limiting MnO₄ (i.e., MnO₄⁻, MnO₄²⁻, or both) species through Nafion™. Voltage profiles for selected cycles of the Nafion™ cell (FIG. 5 Panel b) showed a steady hysteresis and a slight increase in the potential at which charge and discharge curves intersected, which suggests a progressively more oxidized posolyte. In contrast to the Nafion™ cell, there was no apparent change to the discharge capacity of the NZSP_{SA-SSR} cell for close to 100 hours of cycling (FIG. 5 Panel c), indicating that NZSP_{SA-SSR} effectively hindered MnO₄ crossover. We attribute the sudden drop in capacity after 100 hours to a Coulombic imbalance in the cell caused by parasitic, non-Faradaic loss of Zn, e.g., via the hydrogen evolution reaction (HER) [Ref. 34]. Such a parasitic reaction would consume metallic Zn until both sides of the cells are oxidized and comprise Zn(OH)₂ and MnO₄⁻. This hypothesis is consistent with the sharp increase in the average potential during cycling (FIG. 5 Panel d) and UV-vis spectroscopy of the cycled posolyte (FIG. 13), which showed complete conversion of the starting MnO₄²⁻ to MnO₄⁻ but with little net loss of either species.

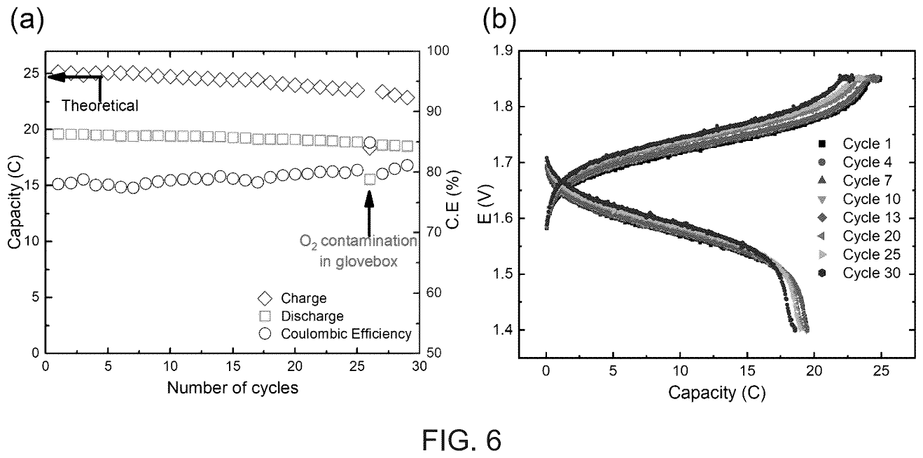

To avoid the problems associated with Zn plating and corrosion, we also assembled a non-hybrid but pH-decoupled flow cell with a slightly alkaline negolyte (pH 8.2) comprising the organometallic complex NaCrPDTA [Ref. 26] and a strongly alkaline (pH 14.3) NaMnO₄-based posolyte, the latter of which was capacity-limiting. FIG. 6 Panel a shows the capacity and current efficiency from this cell over 30 cycles, or four days, which marks one of the longest cycling durations documented for this chromium complex. The cell's current efficiency was approximately 80% indicating that there might be some parasitic or side reactions (e.g., HER) that draw away a considerable amount of current from the main redox processes. FIG. 6 Panel b presents the voltage profiles during cycling which show stable hysteresis and a consistent potential at which charge and discharge curves intersect. This configuration is operable only because NZSP_{SA-SSR} is stable in neutral-pH and strongly alkaline media and highly selective for Na⁺ transport; it is impracticable with a single Nafion™ (or other polymer) membrane unless the pH differential is actively maintained, e.g., using water splitting [Ref. 35, 36].

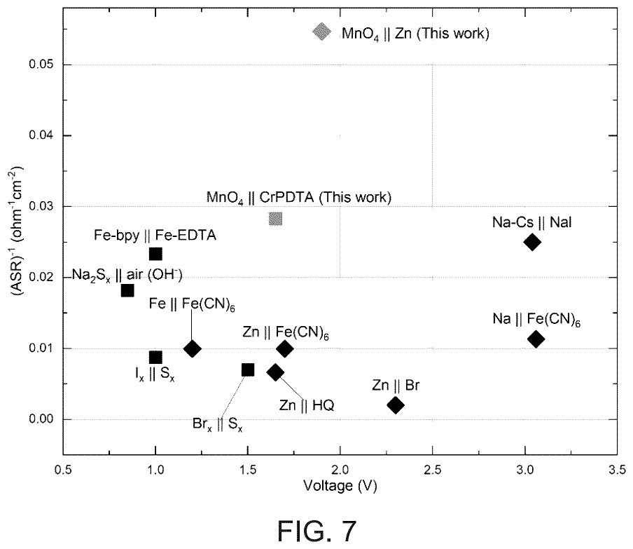

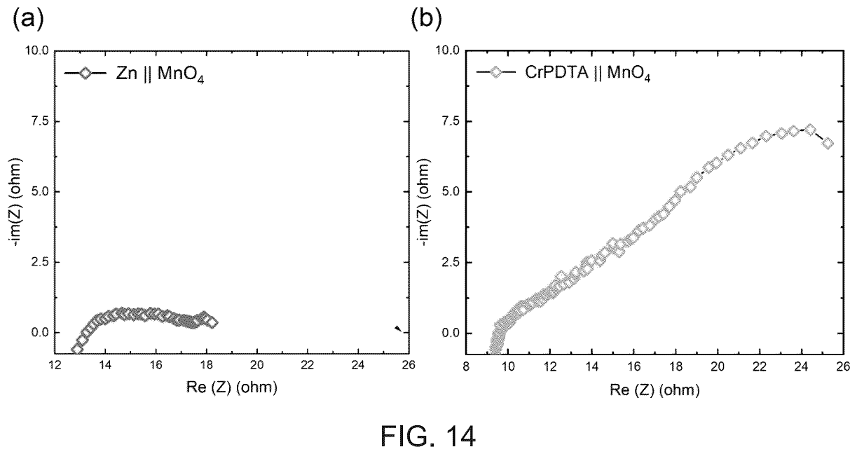

The cell showed an open-circuit potential of 1.65 V, which, to our knowledge, is the highest potential for any non-hybrid aqueous flow cell containing a ceramic membrane, as shown in FIG. 7. Also plotted in FIG. 7 is the reciprocal of the high-frequency area-specific resistance (i.e., area-specific conductance) of the NZSP_{SA-SSR}-containing Zn—MnO₄ and NaCrPDTA-NaMnO₄ cells (EIS spectra are shown in FIG. 14), which exceed analogous values in previously reported NaSICON cells.

### 4. Conclusions

We examined the microstructural and electrochemical stability of NZSP_{COMM} and NZSP_{SA-SSR} under conditions typical of aqueous redox-flow cell testing. SEM, EIS, and ICP-MS measurements showed that NZSP_{SA-SSR} exhibits a very small glassy phase composition and negligible microstructural change while in contact with several aqueous solutions, including with high pH and [K⁺]. A Zn—MnO₄ hybrid redox-flow cell incorporating NZSP_{SA-SSR} demonstrated an open-circuit voltage of 1.9 V, an area-specific resistance of 18 Ω-cm² at room temperature, and no capacity fade for close to 100 hours of cycling. Conversely, using Nafion™ in the same cell resulted in crossover-induced capacity fade at approximately 2% per day. We also assembled a pH-decoupled NaCrPDTA-NaMnO₄ flow cell which had an open-circuit potential of 1.65 V. This Example underscores the importance of synthesizing NaSICON in such a way that its microstructure is stable in high-voltage, inexpensive and durable flow battery applications.

### 5. Experimental Methods

### Materials

### NaSICON Synthesis and Characterization

NaSICON with a composition of Na₃Zr₂Si₂PO₁₂ was purchased from MSE Supplies and was densified via rapid-induction hot-pressing (RIHP) at 1250° C. with flowing argon. Na_{3.4}Zr₂Si_{2.4}P_{0.6}O₁₂ was synthesized by solution-assisted solid-state reaction (SA-SSR), as shown in FIG. 1A Panel a. Stoichiometric amounts of precursors Na₂SiO₃ (sodium metasilicate), Si(OC₂H₅)₄ (TEOS—tetraethyl orthosilicate) and NH₄H₂PO₄ (ammonium dihydrogen phosphate), supplied from Sigma Aldrich, were added in a glass beaker, where water was used as solvent, and stirred at 350 rpm. When a homogeneous mixture was obtained, Zr(OH)₂(NO₃)₂ (zirconium hydroxide nitrate) solution was added and stirred at 70° C. overnight. The resulting powder was then calcined at 750° C. followed by ball milling for three days to break down the agglomerates. The powder went through a final calcination at 700° C. before RIHP at 1225° C. Both the hot-pressed NZSP_{COMM} and NZSP_{SA-SSR} billets (12.7 mm diameter) were cut into pellets around 1 mm thick using a diamond saw. Each pellet was first ground with sandpaper to 1200 grit, then polished using diamond paste up to 0.1 μm.

To determine the phase purity of NaSICON, x-ray diffraction (XRD) was done on the NaSICON pellets before and after soaking in aqueous solutions using Miniflex 600, Rigaku. Cu Kα radiation was used to collect the spectrum from 10° to 40° 2-theta at a rate of 5° min-. Scanning electron microscopy (SEM) was performed on polished NaSICON surfaces to investigate the microstructural changes after soaking in different aqueous-based solutions. SEM images were taken using a Hitachi TM3030 Tabletop Microscope. Laser confocal microscopy was done on polished NaSICON surfaces to measure the surface roughness by using a Keyence VK-X3000 series 3D surface profiler.

### Inductively Coupled Plasma-Mass Spectrometry

Elemental analysis of the water into which NZSP_{COMM} and NZSP_{SA-SSR} pellets were immersed was conducted for Na, Zr, and Si using a Perkin-Elmer NexION 2000 Inductively Coupled Plasma-Mass Spectrometer (ICP-MS) with an analyte detection limit in the 0.1-10 ppb range. A calibration curve was generated using sodium stock solution (100 ppm, 2% HNO₃), silicon stock solution (100 ppm, H₂O/tr.HF), and zirconium stock solution (100 ppm, 2% HNO₃) with diluted concentrations between 1-50 ppb. The samples were prepared by mixing 5 μL of the analyte with 70% HNO₃ and diluted 2000 times with pure Milli-Q water to make up a sample solution containing a final concentration of 2% HNO₃. Yttrium was used as an internal standard (ISTD) and was automatically injected into the sample during the analysis, and three replicas of measurements were taken for each sample and calibration concentration. Syngistix 2.2 software (Perkin-Elmer) was employed to control the system and process the data generated.

### Flow Cell Cycling

Flow cells were constructed with cell hardware from Fuel Cell Technologies (Albuquerque, New Mexico) and assembled into a zero-gap configuration, like a number of previous reports [Ref. 37, 38]. Pyrosealed POCO graphite flow plates with serpentine flow patterns were used for both electrodes. Each electrode comprised a 0.9 cm² (10.7 mm diameter disk) sheet of CE Tech GF020 graphite felt (Fuel Cell Store, 2.1 mm thick). The electrodes were baked in the air for 12 hours at 400° C. prior to use for the alkaline Zn—MnO₄ and pH-decoupled NaCrPDTA-MnO₄ flow cells. The outer portion of the space between the electrodes was gasketed by Viton sheets, with the area over the electrodes cut out to fit two NaSICON pellets. The Nafion™ 117 membrane was immersed in 1 M NaOH for 24 hours before the cell was assembled. The electrodes and membrane were held in place using Viton sheets with the electrode area cut out (two circular holes of diameter 0.9 cm² each for NaSICON and a square-shaped 5 cm² for Nafion™). The torque applied during cell assembly was 55 lb.-in. on each of the eight bolts. A Longer DG-15 peristaltic pump, Cole Parmer SK-77202-60 peristaltic pump, or KNF NFB30 diaphragm pump circulated the electrolytes through the flow cell through fluorinated ethylene propylene tubing (inner diameter= 1/16 in.) sourced from McMaster Carr. Calibration curves were obtained for each pump that permitted translation from the control voltage to a volumetric flow rate in mL/min.

EIS measurements were conducted between 7 MHz and 25 mHz with 6 data points collected per decade over 112 hours on symmetric Na₄Fe(CN)₆/Na₃Fe(CN)₆ flow cells separately containing NZSP_{COMM} and NZSP_{SA-SSR} pellets to determine their impedance stability over time. Both sides of the cell were fed by and emptied into one reservoir containing 0.05 M Na₄Fe(CN)₆ and 0.05 M Na₃Fe(CN)₆ in 0.066 M NaOH (state of charge=50%), circulated at a flow rate of 55 mL/min.

Zn—MnO₄ and NaCrPDTA-NaMnO₄ flow cells were constructed with NZSP_{SA-SSR} pellets as the membrane. The capacity-limiting electrolyte in the Zn—MnO₄ cell was 5 mL 0.18 M Na₂MnO₄ in 3 M NaOH, whereas the non-capacity-limiting electrolyte was 10 mL 0.25 M Na₂Zn(OH)₄ in 4 M NaOH. The CrPDTA-MnO₄ cell was capacity-limited by 5 mL 0.05 M Na₂MnO₄ in 3 M NaOH, and the non-capacity-limiting electrolyte was 25 mL 0.05 M NaCrPDTA in 100 mM Na₂[B₄O₅(OH)₄]·8H₂O buffer (pH=9.5). Prior to cycling, the carbon electrode on the NaCrPDTA side was electroplated with bismuth, as previously reported [Ref. 39]. Flow cell cycling was carried out using a Biologic VSP-300 potentiostat. We performed the cycling experiments using a constant-current, constant-voltage (CCCV) cycling protocol to access the full capacity of the CLE at current densities of 5 mA/cm² and 2.5 mA/cm² for the Zn—MnO₄ and CrPDTA-MnO₄ cells, respectively.

### XRD Measurements

XRD measurements were taken from the surface of NaSICON pellets. In NZSP_{SA-SSR}, there are no discernible peak changes, whereas NZSP_{COMM} exhibits an increase in peak intensity for ZrO₂ at 28° and 31° 2-theta. This observation implies that NZSP_{SA-SSR} demonstrates greater stability than NZSP_{COMM}. Additionally, for NZSP_{SA-SSR} and NZSP_{COMM}, the peak intensity of P2 increased from initially being lower than P1 to slightly surpassing P1 after soaking in DI water, indicating a phase transition from rhombohedral to monoclinic NaSICON. This observation aligns with prior literature findings, which reported that NaSICON in an aqueous environment can undergo hydronium/Na exchange [Ref. 40]. It is important to note that the level of Na and P leaching from NZSP_{COMM} is considerably higher than that observed in NZSP_{SA-SSR}, as indicated by the ICP-MS analysis in FIG. 2 Panel g. This finding suggests that the primary source of Na and P leaching is more likely associated with the glassy phase rather than the grain.

### Estimation of Chemical Cost of Zn—MnO₄ and NaCrPDTA-MnO₄ RFBs

The chemical cost of an RFB ($/kWh) is:

$${C}_{m} = \frac{3600 \times ( \frac{{c}_{p} \times {w}_{p}}{{N}_{p}} + \frac{{c}_{n} \times {w}_{n}}{{N}_{n}} )}{{V}_{cell} \times F \times {η}_{c} \times {Δ}_{SOC}} . \qquad ( 1 )$$

where the variables in Eqn. 1 are shown in Table S2 with subscripts p and n denoting the posolyte and negolyte, respectively.

TABLE S2
Description Of Variables Used In Computing RFB
Costs From Materials And Cell Stack Components.

| Variable | Description | units |
|---|---|---|
| Cₘ | Total chemical cost | $/kWh |
| c | Active material cost | $/kg |
| W | Active material molecular weight | g/mol |
| N | Number of electrons exchanged | |
| V_{cell} | Nominal cell Voltage | V |
| F | Faraday's number | mol e⁻/mol material |
| η_{c} | cell energy efficiency | |
| Δ_{SOC} | accessed SOC range | |

The cost of a vanadium RFB was calculated to benchmark the costs of the two flow cells considered in this Example (Zn—MnO₄ and NaCrPDTA-NaMnO₄). This analysis excludes the cost of all other components, including cell stack components, supporting electrolytes, membrane, carbon felt, tanks, pumps, heat exchangers, and balance of plant. These assumptions lead to a cost of 116 $/kWh for a vanadium RFB, which is considerably lower than the 140 $/kWh recently reported for a more comprehensive analysis [Ref. 41]. The computed chemical cost for Zn—MnO₄ and NaCrPDTA-MnO₄ RFBs were 1.5 and 26.3 $/kWh, respectively.

TABLE S3
Variables Used In Cost Calculations For RFBs Built
Using Vanadium, Zinc, Manganese, and CrPDTA.

| | | Zn\|Mn | |
|---|---|---|---|
| Variable | Vanadium | (Zn(OH)₂\|MnO₂) | NaCrPDTA\|MnO₃ |
| cₙ\|cₚ ($/kg) | 21\|21 | 0.54\|0.46 | 2.99\|0.46 |
| W (g/mol) | 51\|51 | 99.4\|84 | 358.3\|84 |
| N | 1\|1 | 2\|1 | 1\|1 |
| V_{cell} (V) | 1.26 | 1.9 | 1.7 |
| η_{c} | 0.91 | 0.9 | 0.9 |
| Δ_{SOC} | 0.6 | 1 | 1 |

The costs for Zn(OH)₂ and MnO₂ were obtained from https://dir.indiamart.com/accessed on Sep. 1, 2023, and those for CrPDTA from a recent analysis by Darling [Ref. 42].

TABLE S4
EIS Equivalent Circuit Fitted Parameters.

| Membrane | EIS time | R₁ | R₂ | Q₂ | a₂ | R₃ | Q₃ | a₃ | Q₄ | a₄ |
|---|---|---|---|---|---|---|---|---|---|---|
| NZSP_{COMM} | 0 h | 18.06 | 9.958 | 8.05E−08 | 0.9708 | 3.675 | 6.40E−03 | 0.3975 | — | |
| | 112 h | 17.61 | 17.54 | 6.54E−07 | 0.7888 | 3.278 | 1.06E−03 | 0.6053 | — | |
| NZSP_{SA-SSR} | 0 h | 14.21 | 12.57 | 38.234E−09 | 1 | 6.178 | 6.37E−06 | 0.8621 | 0.5472 | 0.1657 |
| | 112 h | 13.64 | 20.77 | 0.193E−06 | 0.8746 | 3.936 | 0.8055 | 0.297 | 80.49 | 0.9276 |

TABLE S5
Literature-Reported Aqueous Flow Cells Using NaSICON Membranes.

| Cell chemistry | E_{OCV}(V) | j (mAcm⁻²) | ASR (Ω-cm²) | ASR⁻¹ (Ω⁻¹cm⁻²) | Ref. |
|---|---|---|---|---|---|
| ^{#}Zn \|\| MnO₄ | 1.9 | 5 | 18.27 | 0.0547 | This |
| | | | | | Example |
| ^{#}NaCrPDTA \|\| MnO₄ | 1.65 | 2.5 | 35 | 0.0286 | This |
| | | | | | Example |
| ^{#}Fe—bpy \|\| Fe—EDTA | 1 | 0.0885 | 42.83 | 0.0233 | Ref. 43 |
| *Na₂Sₓ \|\| air (OH⁻) | 0.85 | 0.325 | 55 | 0.0182 | Ref. 44 |
| *Zn \|\| Br | 2.3 | 5 | 499 | 0.002 | Ref. 45 |
| ^{#}Zn \|\| Fe(CN)₆ | 1.7 | 5 | 100.6 | 0.001 | Ref. 45 |
| ^{#}Fe \|\| Fe(CN)₆ | 1.2 | 5 | 100.6 | 0.001 | Ref. 45 |
| ^{#}Zn \|\| HQ | 1.65 | 1 | 151 | 0.0066 | Ref. 46 |
| ^{#}Sₓ \|\| Br | 1.5 | 1.5 | 143 | 0.007 | Ref. 47 |
| ^{#}Sₓ \|\| I | 1 | 0.5 | 114 | 0.0088 | Ref. 47 |
| *Na—Cs \|\| NaI | 3.04 | 0.0125-0.0375 | 40 | 0.025 | Ref. 48 |
| ^{#}Na \|\| Fe(CN)₆ | 3.06 | 1.5 | 88.42 | 0.0113 | Ref. 49 |

*The ASR value reported.
^{#}ASR calculated from the product of exposed NaSICON membrane area or electrode and grain boundary resistance and the interfacial resistance between the NASICON and liquid electrolyte.

### REFERENCES

[1] Soloveichik, G. L., Flow Batteries: Current Status and Trends. Chemical Reviews 2015, 115 (20), 11533-11558. DOI: 10.1021/cr500720t.
[2] Brushett, F. R.; Aziz, M. J.; Rodby, K. E., On Lifetime and Cost of Redox-Active Organics for Aqueous Flow Batteries. ACS Energy Letters 2020, 879-884. DOI: 10.1021/acsenergylett.0c00140.
[3] Gregory, T. D.; Perry, M. L.; Albertus, P., Cost and price projections of synthetic active materials for redox flow batteries. Journal of Power Sources 2021, 499, 229965. DOI: https://doi.org/10.1016/j.jpowsour.2021.229965.
[4] Albertus, P.; Manser, J. S.; Litzelman, S., Long-Duration Electricity Storage Applications, Economics, and Technologies. Joule 2020, 4 (1), 21-32. DOI: https://doi.org/10.1016/j.joule.2019.11.009.
[5] Sepulveda, N. A.; Jenkins, J. D.; Edington, A.; Mallapragada, D. S.; Lester, R. K., The design space for long-duration energy storage in decarbonized power systems. Nature Energy 2021, 6 (5), 506-516. DOI: 10.1038/s41560-021-00796-8.
[6] Jenkins, J. D.; Sepulveda, N. A., Long-duration energy storage: A blueprint for research and innovation. Joule 2021, 5 (9), 2241-2246. DOI: 10.1016/j.joule.2021.08.002.
[7] Rodby, K. E.; Perry, M. L.; Brushett, F. R., Assessing capacity loss remediation methods for asymmetric redox flow battery chemistries using levelized cost of storage. Journal of Power Sources 2021, 506, 230085. DOI: https://doi.org/10.1016/j.jpowsour.2021.230085.
[8] Perry, M. L.; Saraidaridis, J. D.; Darling, R. M., Crossover mitigation strategies for redox-flow batteries. Current Opinion in Electrochemistry 2020. DOI: https://doi.org/10.1016/j.coelec.2020.03.024.
[9] Li, Z.; Pan, M. S.; Su, L.; Tsai, P.-C.; Badel, A. F.; Valle, J. M.; Eiler, S. L.; Xiang, K.; Brushett, F. R.; Chiang, Y.-M., Air-Breathing Aqueous Sulfur Flow Battery for Ultralow-Cost Long-Duration Electrical Storage. Joule 2017, 1 (2), 306-327. DOI: 10.1016/j.joule.2017.08.007.
[10] Allcorn, E.; Nagasubramanian, G.; Pratt, H. D.; Spoerke, E.; Ingersoll, D., Elimination of active species crossover in a room temperature, neutral pH, aqueous flow battery using a ceramic NaSICON membrane. Journal of Power Sources 2018, 378, 353-361. DOI: https://doi.org/10.1016/j.jpowsour.2017.12.041.
[11] Yu, X.; Gross, M. M.; Wang, S.; Manthiram, A., Aqueous Electrochemical Energy Storage with a Mediator-Ion Solid Electrolyte. Advanced Energy Materials 2017, 7(11), 1602454, https://doi.org/10.1002/aenm.201602454. DOI: https://doi.org/10.1002/aenm.201602454.
[12] Yu, X.; Manthiram, A., A Voltage-Enhanced, Low-Cost Aqueous Iron-Air Battery Enabled with a Mediator-Ion Solid Electrolyte. ACS Energy Letters 2017, 2 (5), 1050-1055. DOI: 10.1021/acsenergylett.7b00168.
[13] Gross, M. M.; Manthiram, A., Rechargeable Zinc-Aqueous Polysulfide Battery with a Mediator-Ion Solid Electrolyte. ACS Applied Materials & Interfaces 2018, 10 (13), 10612-10617. DOI: 10.1021/acsami.8b00981.
[14] Gross, M. M.; Manthiram, A., Long-Life Polysulfide-Polyhalide Batteries with a Mediator-Ion Solid Electrolyte. ACS Applied Energy Materials 2019, 2 (5), 3445-3451. DOI: 10.1021/acsaem.9b00253.
[15] Yu, X.; Yu, W. A.; Manthiram, A., A Unique Single-Ion Mediation Approach for Crossover-Free Nonaqueous Redox Flow Batteries with a Na⁺-lon Solid Electrolyte. Small Methods 2020, 4 (1), 1900697. DOI: 10.1002/smtd.201900697.
[16] Guin, M.; Indris, S.; Kaus, M.; Ehrenberg, H.; Tietz, F.; Guillon, O., Stability of NASICON materials against water and CO₂ uptake. Solid State Ionics 2017, 302, 102-106. DOI: 10.1016/j.ssi.2016.11.006.
[17] Ma, Q.; Tsai, C.-L.; Wei, X.-K.; Heggen, M.; Tietz, F.; Irvine, J. T. S., Room temperature demonstration of a sodium superionic conductor with grain conductivity in excess of 0.01 S cm⁻¹ and its primary applications in symmetric battery cells. Journal of Materials Chemistry A 2019, 7 (13), 7766-7776, 10.1039/C9TA00048H. DOI: 10.1039/C9TA00048H.
[18] Jalalian-Khakshour, A.; Phillips, C. O.; Jackson, L.; Dunlop, T. O.; Margadonna, S.; Deganello, D., Solid-state synthesis of NASICON (Na₃Zr₂Si₂PO₁₂) using nanoparticle precursors for optimisation of ionic conductivity. Journal of Materials Science 2020, 55 (6), 2291-2302. DOI: 10.1007/s10853-019-04162-8.
[19] Hayashi, K.; Shima, K.; Sugiyama, F., A Mixed Aqueous/Aprotic Sodium/Air Cell Using a NASICON Ceramic Separator. Journal of The Electrochemical Society 2013, 160 (9), A1467. DOI: 10.1149/2.067309jes.
[20] Narayanan, S.; Reid, S.; Butler, S.; Thangadurai, V., Sintering temperature, excess sodium, and phosphorous dependencies on morphology and ionic conductivity of NASICON Na₃Zr₂Si₂PO₁₂. Solid State Ionics 2019, 331, 22-29. DOI: https://doi.org/10.1016/j.ssi.2018.12.003.
[21] Mauvy, F.; Siebert, E.; Fabry, P., Reactivity of NASICON with water and interpretation of the detection limit of a NASICON based Na⁺ ion selective electrode. Talanta 1999, 48 (2), 293-303. DOI: 10.1016/s0039-9140(98)00234-3.
[22] Modak, S.; Valle, J. M.; Kang-Ting, T.; Sakamoto, J.; Kwabi, D., Correlating Stability and Performance of NaSICON Membranes for Aqueous Redox-Flow Batteries. ACS Appl Mater Interfaces 2022. DOI: 10.1021/acsami.2c00266.
[23] Hou, M.; Yang, X.; Liang, F.; Dong, P.; Chen, Y.; Li, J.; Chen, K.; Dai, Y.; Xue, D., Multiscale Investigation into Chemically Stable NASICON Solid Electrolyte in Acidic Solutions. ACS Applied Materials & Interfaces 2021, 13 (28), 33262-33271. DOI: 10.1021/acsami.1c07601.
[24] Naqash, S.; Ma, Q.; Tietz, F.; Guillon, O., Na₃Zr₂(SiO₄)₂(PO₄) prepared by a solution-assisted solid state reaction. Solid State Ionics 2017, 302, 83-91. DOI: https://doi.org/10.1016/j.ssi.2016.11.004.
[25] Kimura, M.; Tseng, K.-T.; Wolfenstine, J.; Sakamoto, J., The use of hot-pressing to reduce grain boundary resistance in Nasicon of nominal composition Na₃Zr₂Si₂PO₁₂. Solid State Ionics 2024, 411, 116561. DOI: https://doi.org/10.1016/j.ssi.2024.116561.
[26] Robb, B. H.; Farrell, J. M.; Marshak, M. P., Chelated Chromium Electrolyte Enabling High-Voltage Aqueous Flow Batteries. Joule 2019, 3 (10), 2503-2512. DOI: https://doi.org/10.1016/j.joule.2019.07.002.
[27] Li, C.; Li, R.; Liu, K.; Si, R.; Zhang, Z.; Hu, Y.-S., NaSICON: A promising solid electrolyte for solid-state sodium batteries. Interdisciplinary Materials 2022, 1 (3), 396-416. DOI: https://doi.org/10.1002/idm2.12044.
[28] Valle, J. M.; Huang, C.; Tatke, D.; Wolfenstine, J.; Go, W.; Kim, Y.; Sakamoto, J., Characterization of hot-pressed von Alpen type NASICON ceramic electrolytes. Solid State Ionics 2021, 369, 115712. DOI: https://doi.org/10.1016/j.ssi.2021.115712.
[29] Colli, A. N.; Peljo, P.; Girault, H. H., High energy density MnO₄⁻/MnO₄²⁻ redox couple for alkaline redox flow batteries. Chem Commun (Camb) 2016. DOI: 10.1039/c6cc08070g.
[30] Waters, S. E.; Thurston, J. R.; Armstrong, R. W.; Robb, B. H.; Marshak, M. P.; Reber, D., Holistic design principles for flow batteries: Cation dependent membrane resistance and active species solubility. Journal of Power Sources 2022, 520, 230877. DOI: https://doi.org/10.1016/j.jpowsour.2021.230877.
[31] Kimura, K.; Tseng, K.-T.; Wolfenstine, J.; Sakamoto, J., The use of hot-pressing to reduce grain boundary resistance in NaSICON of nominal composition Na₃Zr₂Si₂PO₁₂. 2024.
[32] Hou, J.; Hadouchi, M.; Sui, L.; Liu, J.; Tang, M.; Hu, Z.; Lin, H.-J.; Kuo, C.-Y.; Chen, C.-T.; Pao, C.-W.; et al., Insights into Reversible Sodium Intercalation in a Novel Sodium-Deficient NASICON-Type Structure: Na_{3.40□0.60}Co_{0.5}Fe_{0.5}V(PO₄)₃. Small2023, 19 (46), 2302726. DOI: https://doi.org/10.1002/smll.202302726.
[33] Park, H.; Jung, K.; Nezafati, M.; Kim, C.-S.; Kang, B., Sodium Ion Diffusion in Nasicon (Na₃Zr₂Si₂PO₁₂) Solid Electrolytes: Effects of Excess Sodium. ACS Applied Materials & Interfaces 2016, 8 (41), 27814-27824. DOI: 10.1021/acsami.6b09992.
[34] Yu, X.; Li, Z.; Wu, X.; Zhang, H.; Zhao, Q.; Liang, H.; Wang, H.; Chao, D.; Wang, F.; Qiao, Y.; et al., Ten concerns of Zn metal anode for rechargeable aqueous zinc batteries. Joule 2023, 7 (6), 1145-1175. DOI: https://doi.org/10.1016/j.joule.2023.05.004.
[35] Metlay, A. S.; Chyi, B.; Yoon, Y.; Wycisk, R. J.; Pintauro, P. N.; Mallouk, T. E., Three-Chamber Design for Aqueous Acid-Base Redox Flow Batteries. ACS Energy Letters 2022, 908-913. DOI: 10.1021/acsenergylett.2c00040.
[36] Yan, Z.; Wycisk, R. J.; Metlay, A. S.; Xiao, L.; Yoon, Y.; Pintauro, P. N.; Mallouk, T. E., High-Voltage Aqueous Redox Flow Batteries Enabled by Catalyzed Water Dissociation and Acid-Base Neutralization in Bipolar Membranes. ACS Central Science 2021, 7(6), 1028-1035. DOI: 10.1021/acscentsci.1c00217.
[37] Barton, J. L.; Milshtein, J. D.; Hinricher, J. J.; Brushett, F. R., Quantifying the impact of viscosity on mass-transfer coefficients in redox flow batteries. Journal of Power Sources 2018, 399,133-143. DOI: https://doi.org/10.1016/j.jpowsour.2018.07.046.
[38] Chen, Q.; Eisenach, L.; Aziz, M. J., Cycling Analysis of a Quinone-Bromide Redox Flow Battery. Journal of The Electrochemical Society 2016, 163, A5057-A5063. DOI: 10.1149/2.0081601jes.
[39] Proctor, A. D.; Robb, B. H.; Saraidaridis, J. D.; Marshak, M. P., Bismuth Electrocatalyst Enabling Reversible Redox Kinetics of a Chelated Chromium Flow Battery Anolyte. Journal of The Electrochemical Society 2022, 169 (3), 030506. DOI: 10.1149/1945-7111/ac56d3.
[40] Wi, T.-U.; Lee, C.; Rahman, M. F.; Go, W.; Kim, S. H.; Hwang, D. Y.; Kwak, S. K.; Kim, Y.; Lee, H.-W., Chemical Stability and Degradation Mechanism of Solid Electrolytes/Aqueous Media at a Steady State for Long-Lasting Sodium Batteries, Chemistry of Materials 2021, 33 (1), 126-135. DOI: 10.1021/acs.chemmater.0c03022.
[41] Zhang M, M. M. W. J. S. Z. T. A.; Counce, R. M., Capital cost sensitivity analysis of an all-vanadium redox-flow battery, J. Electrochem. Soc. 2012, 159, A1183.
[42] Darling, R. M., Techno-economic analyses of several redox flow batteries using levelized cost of energy storage, Current Opinion in Chemical Engineering 2022, 37, 100855. DOI: https://doi.org/10.1016/j.coche.2022.100855.
[43] Allcorn, E.; Nagasubramanian, G.; Pratt, H. D.; Spoerke, E.; Ingersoll, D., Elimination of active species crossover in a room temperature, neutral pH, aqueous flow battery using a ceramic NaSICON membrane, Journal of Power Sources 2018, 378, 353-361. DOI: https://doi.org/10.1016/j.jpowsour.2017.12.041.
[44] Li, Z.; Pan, M. S.; Su, L.; Tsai, P.-C.; Badel, A. F.; Valle, J. M.; Eiler, S. L.; Xiang, K.; Brushett, F. R.; Chiang, Y.-M., Air-Breathing Aqueous Sulfur Flow Battery for Ultralow-Cost Long-Duration Electrical Storage, Joule 2017, 1 (2), 306-327. DOI: 10.1016/j.joule.2017.08.007 (accessed 2017/10/11).
[45] Yu, X.; Gross, M. M.; Wang, S.; Manthiram, A., Aqueous Electrochemical Energy Storage with a Mediator-Ion Solid Electrolyte, Advanced Energy Materials 2017, 7 (11), 1602454, https://doi.org/10.1002/aenm.201602454. DOI: https://doi.org/10.1002/aenm.201602454 (accessed 2021/03/12).
[46] Yu, X.; Manthiram, A., Electrochemical Energy Storage with an Aqueous Zinc-Quinone Chemistry Enabled by a Mediator-Ion Solid Electrolyte, ACS Applied Energy Materials 2018, 1 (2), 273-277. DOI: 10.1021/acsaem.7b00089.
[47] Gross, M. M.; Manthiram, A., Long-Life Polysulfide-Polyhalide Batteries with a Mediator-Ion Solid Electrolyte, ACS Applied Energy Materials 2019, 2 (5), 3445-3451. DOI: 10.1021/acsaem.9b00253.
[48] Liu, C.; Shaw, L., A High Capacity, Room Temperature, Hybrid Flow Battery Consisting of Liquid Na-Cs Anode and Aqueous NaI Catholyte, In Batteries, 2018; Vol. 4.
[49] Senthilkumar, S. T.; Han, J.; Park, J.; Min Hwang, S.; Jeon, D.; Kim, Y., Energy efficient Na-aqueous-catholyte redox flow battery, Energy Storage Materials 2018, 12, 324-330. DOI: https://doi.org/10.1016/j.ensm.2017.10.006.

The citation of any document or reference is not to be construed as an admission that it is prior art with respect to the present invention.

Thus, the invention provides ion-exchange membranes, ion-exchange membranes that can be used in redox flow cells, and methods of making ion-exchange membranes.

In light of the principles and example embodiments described and illustrated herein, it will be recognized that the example embodiments can be modified in arrangement and detail without departing from such principles. Also, the foregoing discussion has focused on particular embodiments, but other configurations are also contemplated. In particular, even though expressions such as “in one embodiment”, “in another embodiment,” or the like are used herein, these phrases are meant to generally reference embodiment possibilities, and are not intended to limit the invention to particular embodiment configurations. As used herein, these terms may reference the same or different embodiments that are combinable into other embodiments. As a rule, any embodiment referenced herein is freely combinable with any one or more of the other embodiments referenced herein, and any number of features of different embodiments are combinable with one another, unless indicated otherwise.

Although the invention has been described in considerable detail with reference to certain embodiments, one skilled in the art will appreciate that the present invention can be practiced by other than the described embodiments, which have been presented for purposes of illustration and not of limitation. Therefore, the scope of the appended claims should not be limited to the description of the embodiments contained herein.

1. An ion-exchange membrane comprising:
a ceramic material having Formula (I): 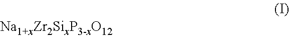
wherein x is between 0 and 3, and
wherein the ceramic material has an area % of a glassy phase of less than 15% when determined using scanning electron microscopy imaging analysis.

2. The ion-exchange membrane of claim 1 wherein:
the area % of the glassy phase is less than 10% when determined using scanning electron microscopy imaging analysis.

3. (canceled)

4. (canceled)

5. The ion-exchange membrane of claim 1 wherein:
the ceramic material has an area % of a ZrO₂ phase of less than 5% when determined using scanning electron microscopy imaging analysis.

6. (canceled)

7. The ion-exchange membrane of claim 1 wherein:
the ceramic material has an area % of grains of greater than 80% when determined using scanning electron microscopy imaging analysis.

8. (canceled)

9. (canceled)

10. The ion-exchange membrane of claim 1 wherein:
the ceramic material exhibits no observable microstructural changes as indicated by scanning electron microscopy after immersion in 1 M KCl for 24 hours.

11. The ion-exchange membrane of claim 1 wherein:
the ceramic material comprises a mixture of rhombohedral and monoclinic phases.

12. The ion-exchange membrane of claim 1 wherein x is between 2 and 3.

13. (canceled)

14. The ion-exchange membrane of claim 1 wherein:
the ceramic material has a relative density of greater than 95%.

15. A method for making an ion-exchange membrane, the method comprising:
(a) combining a first solid comprising sodium, a second solid comprising silicon, and a third solid comprising phosphorus to form a first mixture;
(b) adding a solution of a zirconium-containing compound to the first mixture to create a second mixture;
(c) heating the second mixture at a temperature in a range of 30° C. to 100° C. and drying to form a powder; and
(d) applying simultaneous heat and pressure to the powder to form an ion-exchange membrane comprising a ceramic material having a Formula (I): 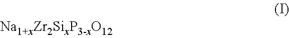
wherein x is between 0 and 3.

16. The method of claim 15 wherein x is between 2 and 3.

17. (canceled)

18. (canceled)

19. (canceled)

20. (canceled)

21. (canceled)

22. The method of claim 15, wherein step (d) comprises using a hot-pressing technique.

23. (canceled)

24. (canceled)

25. The method of claim 15, wherein the heat is applied at a temperature in a range of 1000° C. to 1400° C.

26. (canceled)

27. The method of claim 15, wherein the pressure applied is between 5 and 80 MPa.

28. (canceled)

29. (canceled)

30. (canceled)

31. (canceled)

32. (canceled)

33. (canceled)

34. (canceled)

35. (canceled)

36. (canceled)

37. (canceled)

38. The method of claim 15, wherein step (c) further comprises calcining the powder.

39. (canceled)

40. (canceled)

41. An aqueous redox flow cell comprising:
a positive electrode;
a negative electrode;
a posolyte compartment containing a posolyte wherein at least a part of the positive electrode contacts the posolyte;
a negolyte compartment containing a negolyte wherein at least a part of the negative electrode contacts the negolyte; and
an ion-exchange membrane positioned to separate the positive electrode and the posolyte from the negative electrode and the negolyte,
wherein the ion-exchange membrane comprises a ceramic material having Formula (I): 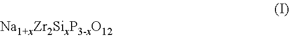
wherein x is between 0 and 3, and
wherein the ceramic material has an area % of a glassy phase of less than 15% when determined using scanning electron microscopy imaging analysis.

42. The flow cell of claim 41 wherein:
the area % of the glassy phase is less than 10% when determined using scanning electron microscopy imaging analysis.

43. (canceled)

44. (canceled)

45. (canceled)

46. (canceled)

47. The flow cell of claim 41 wherein:
the flow cell has an open-circuit voltage greater than 1.5 V.

48. (canceled)

49. (canceled)

50. (canceled)

51. (canceled)

52. (canceled)

53. (canceled)

54. (canceled)

55. (canceled)

56. (canceled)

57. (canceled)

58. (canceled)

59. (canceled)

60. (canceled)

61. (canceled)

62. (canceled)

63. (canceled)

64. (canceled)

65. (canceled)

66. (canceled)

67. (canceled)

68. (canceled)

69. (canceled)

70. (canceled)

71. (canceled)

72. (canceled)

73. (canceled)

74. (canceled)

75. (canceled)

76. (canceled)

77. (canceled)

78. (canceled)

79. (canceled)

80. (canceled)

81. An ion-exchange membrane comprising:
a ceramic material having Formula (II): 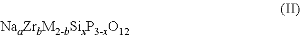
wherein M is selected from the group consisting of Mg, Ca, Sc, Yb, Co, Zn, La, Ce, and mixtures thereof,
wherein a is between 1 and 6, and
wherein b is between 1 and 2, and
wherein x is between 0 and 3, and
wherein the ceramic material has an area % of a glassy phase of less than 15% when determined using scanning electron microscopy imaging analysis.

82. (canceled)

83. (canceled)

84. (canceled)

85. The ion-exchange membrane of claim 81 wherein:
the ceramic material has an area % of a ZrO₂ phase of less than 5% when determined using scanning electron microscopy imaging analysis.

86. (canceled)

87. (canceled)

88. (canceled)

89. (canceled)

90. The ion-exchange membrane of claim 81 wherein: M is Mg.

91. (canceled)
